(19) United States
(12) Patent Application Publication
(10) Pub. No.: US 2012/0150562 A1
(43) Pub. Date: Jun. 14, 2012

(54) HEALTH CARE PRODUCT TRIAGE ADMINISTERED CLOSED SYSTEM

(76) Inventor: Keith S. Lerner, Livingston, NJ (US)

(21) Appl. No.: 13/311,416

(22) Filed: Dec. 5, 2011

Related U.S. Application Data
(60) Provisional application No. 61/421,546, filed on Dec. 9, 2010.

(51) Int. Cl. G06Q 50/22

(52) U.S. Cl. 705/3; 705/2

(57) ABSTRACT

A controlled, closed marketing, sales and distribution system for health-care related products, comprising a processor, and memory comprising program instructions. The program instructions are executable by the processor to store a set of health risk factors associated with the controlled distribution product, receive consumer requests to purchase the controlled distribution product, retrieve end-user information related to the set of health risk factors associated with the controlled distribution product, determine whether the consumer is authorized to purchase the controlled distribution product based on the end-user consumer information, and sell the consumer the controlled distribution product when the consumer is authorized to purchase.

### CROSS-REFERENCE TO RELATED APPLICATION

This application claims the benefit of U.S. Provisional Patent Application No. 61/421,546, filed Dec. 9, 2010, the entire disclosure of which is incorporated by reference herein.

### BACKGROUND

1. Field

This disclosure relates generally to the marketing, sale and distribution of regulated health care products to consumers or to health practitioners' patients, and, more particularly, to a computer-implemented health care product triage administered closed system.

2. Background

A plethora of protective restrictions are currently imposed by regulatory agencies on the sale of certain health care products. These restrictions may impose significant financial and/or social costs on sellers, buyers and intermediaries (such as physicians or third party insurance companies) that may assess and/or control the use of and payments associated with these products. Products falling under these restrictions are often categorized into classes, some having fewer associated restrictions and others having more associated restrictions. Generally the restrictions relate to promoting the safe use of the product, but other factors may impact these groupings, such as protecting the public (as in the case of pseudoephedrine products that were available over-the-counter, but were moved behind-the-counter to protect against the illicit preparation and sale of crystal methamphetamine). A similar regulation applies to “Plan B®” which is a contraceptive that can prevent unwanted pregnancy if it is taken with 72 hours of unprotected intercourse. The Food and Drug Administration (FDA) considers Plan B® to be available “Over-the-Counter” (OTC) for women aged 17 or over, but a prescription drug for women younger than 17. Furthermore, some “Schedule V” controlled substances may be classified as OTC products in certain U.S. States. Such drugs are sold without a prescription, but are subject to record-keeping rules, quantity and/or age restrictions, and must be dispensed by a pharmacy.

In the United States, pharmaceutical products, medical devices and other healthcare related products for human use and for animal use are legally grouped into two distinct classes: “Prescription” and “Non-Prescription.” Prescription products are only available to consumers after receiving a prescription as a “patient” of an authorized prescriber (such as a physician, physician's assistant, podiatrists, dentist, nurse practitioner, optometrist, ophthalmologist, etc.). Non-prescription products can generally be purchased without a prescription. OTC non-prescription products are selected and purchased by the consumer themselves at retail without pharmacist intervention, or through various forms of e-commerce. These OTC products may be sold anywhere such as supermarkets, mass marketers, convenience stores, etc. The FDA requires that OTC products be labeled with an approved Drug Facts label to educate consumers about the proper use of these medications. Labels are standardized and must be easy for most consumers to understand. Drug Facts labels include information on the product's active ingredient(s), inactive ingredients, indications and purpose, safety warnings, directions for use, etc.

A poorly defined, implied, but not legally defined, second category of non-prescription products in the United States, comprises products that are subject to other restrictions on sale. While these products are legally classified as non-prescription OTC drugs, they are typically stored behind the pharmacy counter and are only sold in stores employing a registered pharmacist. Such items are commonly referred to as “Behind-the-Counter” (BTC) products and are unavailable in convenience or grocery stores that stock other non-restricted OTC medications. BTC products, among other possible requirements, require a consultation with and/or authorization by a pharmacist prior to making a purchase. Ostensibly, pharmacist counseling aids in making determinations on a variety of factors, such as authorizing a consumer to buy a product, tracking product usage frequency, and limiting the amount of product sold to the consumer in a given time period (such as, for example, for pseudoephedrine-based nasal decongestants). However, pharmacist delivered counseling to consumers in a retail setting, particularly in very busy stores, is frequently an inadequate means of providing fully appropriate screening of individuals to use certain healthcare products and/or information on the use of the products to maximize consumers health and safety benefits when using such products.

Certain non-prescription products may actually require an initial prescription to specify a product type and dose, but in some States are refillable without a prescription thereafter (e.g., insulin and syringes). For example, although requirements may differ by State, insulin products, such as Beef, Pork, Beef-Pork, and the synthetic “human” insulins are usually sold as BTC products without a prescription. However, pharmacies in some States may require an initial prescription. Some States allow unlimited refills while others require a prescription once annually. The legal regulation of syringe access varies from state to state, but takes one or more of three forms: syringe prescription laws and regulations; other pharmacy regulations or miscellaneous statutes imposing a variety of restrictions on the sale of syringes by pharmacists or others; and drug paraphernalia laws prohibiting the sale or possession of items intended to be used to consume illegal drugs. Laws on drug possession may also be applied in a manner that, in practical terms, regulates the possession of syringes, and so must also be considered for their possible effects on syringe access. Generally, syringes do not require a prescription, but the buyer is usually required to demonstrate a legitimate medical purpose for the purchase.

Similar distinctions exist in other countries as well, but many countries have a formal three tier categorization of health care products: Prescription Only, Pharmacy Only (which may also be known as “Counter Prescribing” or “Behind-the-Counter” in some countries) and General Sales List (GSL). In Canada, the national model consists of three schedules or four categories: Schedule I, Schedule II, Schedule III and Unscheduled, with specific factors and conditions for sale expected for each. Pharmacy Only products may require some level of pharmacist intervention or supervision to sell the product, but not a physician's prescription. The pharmacist determines whether the medicine is safe for the particular customer based on the customer's responses to a set of questions, but many pharmacies sell such medicines with no questions asked. Examples of these include some sleep aid tablets such as Nytol®, human de-worming tablets such as Mebendazole, painkillers with small amounts of codeine (up to 12.8 mg per tablet), and pseudoephedrine. GSL products or similar products are available “off the shelf” (similar to most OTC medicines in the United States) and require no pharmacist intervention to sell. As a result, they can generally be sold anywhere (e.g., retail outlets, convenience stores, supermarkets, etc.).

Furthermore, in the United States, some non-prescription products and nutritional supplements are also currently sold directly to consumers through food stores, convenience stores, mass merchandisers, Internet websites and “direct-to-consumer infomercials.” Such products are regulated so that they could also be sold in an open, unrestricted manner for consumer purchase in retail stores if the product distributor so desired.

Because of greater availability and fewer restrictions compared to prescription drugs, non-prescription products naturally service a far larger commercial market in terms of the number of actual users of many healthcare products. However, due to sizeable pricing premiums for prescription products, the commercial market for prescription drugs is often valued much higher than for non-prescription products, especially after a prescription product is “switched” to non-prescription regulatory status.

Restrictions on prescription products, while intended to keep patients safe, may impose a cost from a public health standpoint, because many consumers cannot afford the cost of prescription products, health insurance and/or physician's fees. They may choose instead to forego prescription medication and either leave their medical condition(s) untreated or rely on other, potentially less safe or potentially less effective remedies, such as folk remedies, Homeopathic medicine, Ayurvedic medicine and/or nutritional or other supplementation.

As prescription-only products move toward the end of their patent exclusivity period, it is sometimes desirable for a pharmaceutical or medical device manufacturer to move these products from prescription to non-prescription status. When a prescription product loses its patent protection, it is highly vulnerable to generic drug competition. The US Food and Drug Administration defines an Rx-to-OTC switch as non-prescription marketing of a drug product that was once a prescription-only drug for the same indication, with the same strength, dose, duration of use, dosage form, treatment population and route-of-administration. Once switched, a product matching the identical specifications cannot be sold simultaneously as both prescription and non-prescription products. Therefore, a manufacturer may take advantage of this regulation by switching a drug from prescription to non-prescription status, thereby deterring generic forms of the prescription product from reaching the market. Furthermore, in switching prescription products to non-prescription status, the manufacturer can often reach a larger market for the product and lengthen the marketable lifespan of the product. Therefore, it is clear that there are various advantages for manufacturers who are able to switch products from prescription to non-prescription status.

In the United States, manufacturers may petition the FDA for a regulatory status change from prescription to non-prescription status. The FDA has outlined five general requirements governing whether a prescription product may be shifted to non-prescription status. First, the medicinal or medical benefits of the product must outweigh the expected health risks involved when using the product. Second, the potential for product abuse must be low. Third, the effects of the product should address consumer self-diagnosable issues without masking an underlying serious disease. Fourth, the product must have characteristics that allow it to be adequately labeled, such that consumers can safely use the product in a proper manner. Fifth, the product must be appropriately, safely and effectively useable without requiring guidance or intervention from a health care practitioner.

Two types of studies must be conducted to illuminate whether the product meets these last two requirements. The first type of study, called a “Label Comprehension Study,” requires a manufacturer to show that a designated proportion of consumers would clearly understand the “primary label communication points” on a label for the product in consideration. The “primary label communication points” constitutes information on the label that has the greatest clinical significance, and includes product usage indications, dose and dose interval, contraindications, warnings, drug interactions and when to stop using the product. In addition, a manufacturer is required to show that a designated proportion of consumers would clearly understand the “secondary label communication points,” which address areas of less critical importance (e.g., general health information). Other key communication points may also be required. The specific end points for a particular product may vary since “adequate” label communication is an issue of clinical judgment and varies depending upon the medical significance of a particular communication objective.

The second type of study, called an “Actual Product Use Study,” may be used to investigate how a current prescription-only product would be used if it were procured in an actual non-prescription, buying situation. The Actual Product Use Study may test for a plurality of factors, such as adherence (which considers consumption of the drug and monitors users for efficacy and safety in accordance with the drug label), safety (which considers experienced negative effects of the drug, or adverse events (AE's) that occur during the study), and efficacy (which determines whether the clinical benefit in the prescription setting is reproducible in the non-prescription setting).

These studies must be conducted with scientific rigor, and include all subject categories that could potentially use the product, regardless of age, gender, underlying medical condition and use of concomitant medications. The Label Comprehension Study must test label comprehension even among market segments that have no expressed interest in using the product. It must also consider consumers with low literacy levels, representing a range of literacy below an eighth-grade reading level. As a result, these requirements present a serious problem for manufacturers seeking to shift their product lines from prescription to non-prescription status. Because of the large variation in consumer population segments, it is oftentimes impossible to create an adequate label that will satisfy all of the FDA's requirements. Consequently, a product that passes rigor in all other areas may fail to qualify for non-prescription status due to the difficulty inherent in creating a satisfactory non-prescription label.

Given the aforementioned restrictions, which may be potentially confusing to consumers, and the limited time and training available for pharmacists to help consumers diagnose disorders and use disease and health disorder treatment, and health maintenance products properly as intended by regulatory authorities, there is need for an alternative system that addresses these systemic problems to ultimately improve consumer understanding which promotes the safe and effective use of such products, while also expanding the range of health products that are available to consumers without a prescription.

### BRIEF SUMMARY

In one aspect of this disclosure, a controlled, closed marketing, sales and distribution system for health-care related products is disclosed. The system comprises a processor, and memory comprising program instructions. The program instructions are executable by the processor to store a set of health risk factors associated with the controlled distribution product, receive consumer requests to purchase the controlled distribution product, retrieve consumer information related to the set of health risk factors associated with the controlled distribution product, determine whether the consumer is authorized to purchase the controlled distribution product based on the consumer information, and sell the consumer the controlled distribution product when the consumer is authorized to purchase.

In another aspect of this disclosure, a computer-implemented system and method is disclosed for controlling the closed distribution of regulated health care related products. A database coupled to a processor includes a listing of at least one healthcare related product of a type that is access controlled based upon predefined medical criteria. Qualification factors for each of the listed healthcare related products is stored in the database, the qualification factors specifying medical information that must be satisfied before the healthcare related product can be distributed to an end user of the healthcare related product. A customer interface is provided through which requests can be made to obtain healthcare related products for the end user. A communication link is provided through which distribution of the healthcare related products can be directed. A triage module, implemented by program instructions executable by the processor, interacts with the customer interface to receive a request from a requesting customer to purchase at least one healthcare related product listed in the database. The triage module accesses the database to obtain the qualification factors for the requested healthcare related product and receives medical information relating to the end user of the requested healthcare related product that can be used to determine whether the qualification factors for the requested healthcare related product are satisfied. The triage module determines whether the qualification factors are satisfied based on the received medical information and issues an indication via the communication link that the requested healthcare related product should be distributed to the end user if the qualification factors are satisfied. If any of the qualification factors are not satisfied, the triage module causes the customer interface to indicate to the requesting customer that further action is required to satisfy the remaining qualification factors before the requested healthcare related product may be distributed to the end user.

In another aspect of this disclosure, a computer-implemented system and method is disclosed for controlling the closed distribution of regulated health care related products. A request to purchase a healthcare related product listed in a database is received from a requesting customer via a customer interface, the healthcare related product of a type that is access controlled based upon predefined medical criteria. Qualification factors stored in the database for the requested healthcare related product are accessed using the processor. The qualification factors specify medical information that must be satisfied before the requested healthcare related product can be distributed to an end user of the requested healthcare related product. Medical information relating to the end user of the requested healthcare related product is received using the processor and the processor determines whether the qualification factors for the requested healthcare related product are satisfied based on the received medical information. An indication is issued via a communication link that the requested healthcare related product should be distributed to the end user if the qualification factors are satisfied.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a high level representation of the logical components included or interacting with an illustrative closed marketing, sales and distribution system;

FIG. 2 is a flow chart representing a preferred sequence of steps for implementing the illustrative closed marketing, sales and distribution system of FIG. 1;

FIG. 3A is a flow chart representing a continued preferred sequence of steps for implementing the illustrative closed marketing, sales and distribution system of FIG. 1;

FIG. 3B is a flow chart representing a continued preferred sequence of steps for implementing the illustrative closed marketing, sales and distribution system of FIG. 1;

FIG. 4A is a flow chart representing a continued preferred sequence of for implementing the illustrative closed marketing, sales and distribution system of FIG. 1;

FIG. 4B is a flow chart representing a continued preferred sequence of for implementing the illustrative closed marketing, sales and distribution system of FIG. 1;

FIG. 5 is a flow chart representing a continued preferred sequence of for implementing the illustrative closed marketing, sales and distribution system of FIG. 1;

FIG. 6 is a flow chart representing a continued preferred sequence of for implementing the illustrative closed marketing, sales and distribution system of FIG. 1;

FIG. 7 is a flow chart representing a continued preferred sequence of for implementing the illustrative closed marketing, sales and distribution system of FIG. 1;

FIG. 8 is a flow chart representing a continued preferred sequence of for implementing the illustrative closed marketing, sales and distribution system of FIG. 1;

FIG. 9 is a flow chart representing a continued preferred sequence of for implementing the illustrative closed marketing, sales and distribution system of FIG. 1;

FIG. 10A is a flow chart representing a continued preferred sequence of for implementing the illustrative closed marketing, sales and distribution system of FIG. 1;

FIG. 10B is a flow chart representing a continued preferred sequence of for implementing the illustrative closed marketing, sales and distribution system of FIG. 1;

FIG. 10C is a flow chart representing a continued preferred sequence of for implementing the illustrative closed marketing, sales and distribution system of FIG. 1;

FIG. 11 is a flow chart representing a continued preferred sequence of for implementing the illustrative closed marketing, sales and distribution system of FIG. 1;

FIG. 12 is a flow chart representing a continued preferred sequence of for implementing the illustrative closed marketing, sales and distribution system of FIG. 1;

FIG. 13 is a flow chart representing a continued preferred sequence of for implementing the illustrative closed marketing, sales and distribution system of FIG. 1; and

FIG. 14 is a flow chart representing a continued preferred sequence of for implementing the illustrative closed marketing, sales and distribution system of FIG. 1.

### DETAILED DESCRIPTION

This application discloses a health care product “Triage Administered Closed System” (TACS) and method for enabling broader sale and classification of prescription and/or non-prescription health care products, (or for other health care product regulatory classification(s) which may not as yet be legislated) which are meant to regulate drugs, biologics, medical devices, diagnostic and/or genetic test kits or any combinations of these. It is contemplated that TACS Products sold in the manner to be described will meet the current or future criteria (consistent with this disclosure) for such products under any regulatory status including switching from one regulatory status to another. Moreover, with the inclusion of enhanced consumer education, comprehensive and fully capturable product orders, sales and product returns data, product usage tracking and analysis, pre- and post-purchase product counseling, health and health risk profiling and product compliance coaching, TACS is expected to enable this regulatory status change for certain prescription products that would not otherwise be approved for sale under conventional OTC or BTC selling methods. In addition, TACS may offer Regulators the opportunity to create new sub-classifications within the current prescription and non-prescription regulatory classifications (or, for example, in the case of Canada, within Schedules I, II and III), which would allow the sale and distribution of healthcare products to individuals through a closed distribution system where this might have been previously prohibited in an Open distribution system or otherwise outside of the TACS system. Also, TACS is expected to potentially create, for all intents and purposes, a new space to sell healthcare products which may fall somewhere in between conventional prescription-only and OTC or BTC products which does not currently exist today.

TACS may be considered a “closed” system and method because it preferably enables complete control, transparency and tracking of 100% of TACS Product purchases, which may include data on when those purchases were made, which products were purchased (including lot number, expiration date, etc.), what was actually dispensed, where it was dispensed, how it was dispensed and (with respect to the consumer's medical condition) why it was dispensed. A TACS Triage Service may be implemented to provide a centralized control schema for organizing and storing this data. The richness of the data may provide a high level of control over consumer use authorization and distribution of authorized products to consumers.

As used herein, the terms “consumer” and “TACS consumer” are intended to relate to the end user of the TACS product. While it is envisioned that TACS products may be purchased by the end user or by other requesting customers on behalf of the end user (e.g., parent, guardian, physician, etc.), medical information used by TACS 100 to qualify the distribution of the TACS Product is intended to relate to the end user of that healthcare related product.

Examples of drug types that may be sold through TACS as non-prescription TACS Products include (but are not limited to) treatments for diabetes, thyroid disease, hypertension, high cholesterol, many diseases of the skin, etc. An example of a medical device that may be sold through TACS as a non-prescription TACS Product may include (but is not limited to) contact lenses. Other products that may be switched from prescription to non-prescription status under TACS may include chronic use “maintenance” and disease prevention products with a benefit-to-risk therapeutic index somewhere in between the corresponding therapeutic indexes of current prescription products and the therapeutic indexes of current non-prescription OTC drugs.

TACS also preferably includes a Triage Service responsible for determining purchasing eligibility, and counseling consumers on products they purchase through TACS. By implementing the proposed TACS methodology, a Triage Service may adequately identify candidates who can safely and effectively use the product, and provide counsel to them in the safe and effective use of the product on an initial and possibly ongoing basis. Therefore, the usual need for (at least) some medical intervention from a physician may be eliminated. This may enable a broader range of consumers (including those with limited and/or poor education) to better comprehend appropriate product usage. The inclusion of product candidate screening, purchasing approval, product information counseling, informative product advertising and/or other support or product approval processes may be integrated into TACS.

Because Triage Service-based counseling is not locked into any particular format, it offers superior education and instruction on use, advantages, and dangers of the product, and it may be adjusted to any segment of the population. Additionally, because Triage Service is envisioned as a nation-wide and globally available international service, consumers with questions may contact the Triage Service at any time, anywhere in the world, long after sale of the product has been completed. Therefore, TACS alleviates many communication issues because it introduces the possibility of medical education through informative advertising, and/or live guidance from a Triage service which would preferably be available on a 24-hour a day, seven day a week basis.

It is further anticipated that more robust and generally superior consumer education will be considered advantageous by a regulatory authority. As a result, a regulatory authority may approve of a practice where certain healthcare products are offered for sale to consumers only through TACS, preferably on an exclusive basis. As a result, conventional channels, such as OTC, BTC and physician-based prescription may be barred from selling these exclusive products by the same regulatory authority. Alternatively, TACS may be used to expand the available channels used to market, sell and distribute both prescription or non-prescription healthcare products to patients or to consumers directly. In cases where TACS is the only available channel, consumers may preferably utilize TACS to purchase the product and, in doing so, will also gain the healthcare benefits inherent to the channel described in this disclosure. This exclusivity is what may enable a regulatory authority to switch the product from prescription regulatory classification to a new non-prescription TACS “exclusive” (or on a semi-exclusive basis, a TACS “preferred”) status, thereby adopting new TACS protocols as implemented in the system and process described below.

Prices for non-prescription TACS exclusive products may be reduced compared to the same products when they would be sold as prescription-only because direct sale of exclusive products to consumers would eliminate the need for wholesaler inventories, logistics, third party “payor” and/or other trade channel “middle-man” mark-ups. Prices may also be lower because, presumably, prescription-only products near the end of their patent protection period will have already recouped much of their product development costs, so the burden on health care companies to maintain disproportionately higher pricing compared to off-patent generic prescription drugs could be greatly reduced. These factors, in conjunction with the greater availability afforded by the TACS protocols, may result in a net public health benefit, as consumers have broader and easier access to former prescription products at presumably lower prices. Additionally, third party insurance payor programs may no longer be expected to cover all or part of the cost of non-prescription products, and physicians would be freed from treating patients with many conditions who could treat themselves instead through TACS, thereby alleviating administrative burdens and costs for consumers, health care providers, governmental agencies and insurance companies alike.

TACS may also utilize Electronic Medical Record (EMR) and/or Electronic Health Record (EHR) computer programs with data management technology specific to heath care records, which preferably enables TACS to maintain permanent (or semi-permanent), but still HIPAA compliant or other means of protected, confidential health records for consumers who purchase TACS products. This may allow TACS to store, retrieve, analyze, ascertain, flag and document changes in a consumer's health risk profile over time, thereby enabling beneficial modifications to be made with regard to the consumer's TACS Product regimen. If communicated to the consumer or the health care professional overseeing the consumer's health, TACS can also enable beneficial modifications to be made with regard to the consumer's prescription and/or non-prescription product regimen(s). Preventative modifications may also be made, including, for example, preventing the sale of certain TACS Products to a consumer if contraindicated, and urging the consumer to see a physician if a higher level of supervised medical attention is warranted.

Individual product purchases are preferably stored and tracked by purchase date, stock-keeping unit, lot number and health care product company control number, etc., thereby allowing for analysis of consumer purchases and full control over future sales or product returns. This may be done to prevent, for example, product abuse by a consumer, or add partial physician oversight to product use. This captured information also enables superior product recall management compared to “open system” (prescription, OTC or BTC) sales channel recall methods that do not track purchases for each individual consumer in as detailed a manner as TACS, which makes for fast and efficient communication to specific consumers who actually purchased recalled products. Oftentimes, open system product advertisements, notices or more general messages are sent to the households of consumers who may have purchased or consumed the product without knowing whether or not these consumers actually did purchase or consume it. Therefore, the TACS closed system is advantageous relative to current open product systems. For example, a product recall on a non-prescription product might currently reach only a portion of the consumers who purchased the product. Using TACS, however, targeted communications may be made to each and every purchaser because buyer information would preferably be available in a centralized database accessed and only retrievable by TACS.

One of the most significant factors influencing poor treatment outcomes of both prescription and non-prescription products is related to poor usage compliance of the products. For example, users of drugs may under- or overdose themselves, or may not remember to take the medication at the correct dosing interval, therefore failing to follow labeled dosing directions. TACS may provide product usage compliance coaching and or follow-up check-ins with consumers as an optional service. Such consumer contacts can encourage the proper use of the product and, therefore, enable better treatment outcomes with potentially fewer adverse events.

Entities that may utilize or approve of the TACS system and method may include for example, in the United States, the FDA, Center for Drug Evaluation and Research (CDER) and/or Center for Devices and Radiological Health (CDRH) and any other regulatory authority, and medical practices, clinics, hospitals, etc., situated in the United States and in other countries abroad. For animal health product applications of TACS, TACS may be utilized by the Center for Veterinary Medicine (CVM), the branch of the FDA that regulates food, food additives, and drugs that are given to animals, including food animals and pets or by the United States Department of Agriculture that regulates vaccines for animals.

In sum, the disclosed TACS methodology will benefit consumers by enabling a larger range of prescription and non-prescription healthcare products that can be sold to consumers for themselves, their family members, or animals under their care, while simultaneously improving consumer safeguards via superior product information, product counseling, monitoring of product purchases, and use and coaching for proper product compliance post purchase. TACS addresses many deficiencies with current “open system” Prescription and OTC or BTC sales methodologies and, in many respects, may provide superior product safety and product usage controls compared even to what is available for prescription-only products. Current systems with little or no consumer counseling are deficient because pharmacists are not particularly well trained or have the time to fully counsel patients and a busy pharmacy is often not an ideal setting for serious product counseling. Poor provisions exist for patient screening, follow-up and documentation of product use, thereby making it difficult to detect patient misuse or abuse (and indeed, sometimes no such provisions exist at all). In contrast, TACS Triage Service counseling, product sales and TACS EMR/EHR-enabled consumer record keeping may improve upon these factors for any healthcare products that may be sold through the TACS closed system.

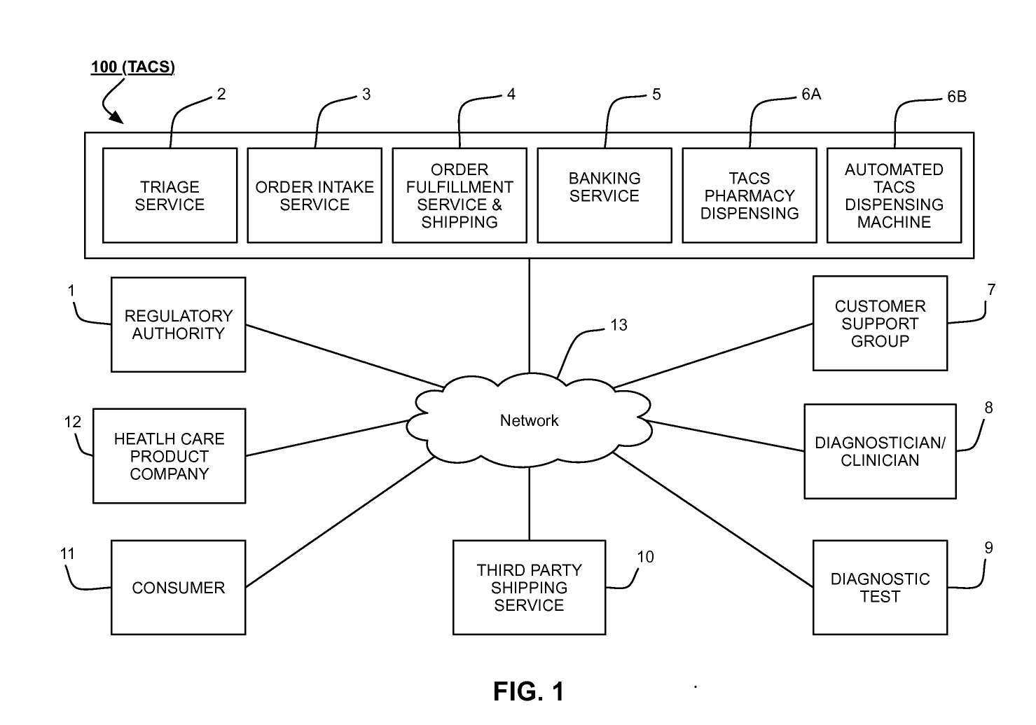

FIG. 1 is a high level representation of the preferred components of an illustrative embodiment of TACS 100. TACS 100 may be implemented utilizing one or more computing systems of varying configuration. Each computing system preferably includes computing components for executing computer program instructions and processes. These components may include a central processing unit (CPU), memory, input/output (I/O) devices and a network interface.

The CPU processes and executes computer program instructions. Random access memory (RAM) and/or fast access cache memory preferably provides fast data supply to CPU. Long-term storage may be provided as a more permanent form of computer memory, and may be, for example, a hard disk, optical disk, flash memory, solid-state memory, tape, or any other type of memory. The database may exist at an onsite TACS facility (if one exists) or, it may be implemented via “cloud-computing” enabled data storage and retrieval.

The network interface device may provide the computing system with access to a Network 13, which may be a wireless or wired connection. Network 13 may be, for example, the Internet, a corporate intranet, or any other computer network through which the computing system may connect to or otherwise communicate with other computers and databases for specialized information that may be necessary for implementation of TACS 100. Network 13 may also represent other types of networks, such as telephone networks or cable networks. Any network suitable for communication between consumers, TACS 100 and TACS-related components may be included as appropriate.

Regulatory Authority module 1 may represent one or more computer systems and processes controlled and/or utilized by a regulatory authority, such as (but not limited to) the FDA, CDER and/or the CDRH, etc. Regulatory Authority module 1 may be adapted to meet any requirements such an authority would desire for implementation of the TACS 100. For example, a regulatory authority may require full cataloguing and regular reporting of all transactions carried out under the TACS 100, including details such as (but not limited to) disease classification, product type, consumer identification and purchaser's address, phone number, etc. Under this requirement, TACS 100 may communicate that information automatically to the regulatory authority by communicating with Regulatory Authority module 1. Such information may be relayed to the Regulatory Authority module 1 by, for example, electronic conveyance via Network 13. TACS 100 and Regulatory Authority module 1 may also be required to communicate with a health care product company responsible for manufacturing, marketing, selling and/or distributing TACS applications, processes and/or products sold via TACS 100. TACS 100 may, therefore, communicate directly with Health Care Product Company module 12, a module responsible for supporting the health care product company (encompassing at least health care product manufacturing, marketing and/or selling), which may then analyze the data and subsequently communicate its findings and recommendations to Regulatory Authority module 1 in turn.

Triage Service module 2, Order Intake Service module 3, Order Fulfillment & Shipping Service module 4, Banking Service module 5, TACS Pharmacy Dispensing module 6A and Automated TACS Dispensing Machine module 6B are preferably be included as components of TACS 100. In accordance with the system description above, Triage Service module 2, Order Intake Service module 3, Order Fulfillment & Shipping Service module 4, Banking Service module 5, TACS Pharmacy Dispensing module 6A and Automated TACS Dispensing Machine 6B may be implemented as one or more computer systems, software processes operating on one or more computers concurrently, and/or database computer systems, etc. Alternatively, these modules may be implemented as distinct logistical components of TACS 100, housed in separate systems, intercommunicating with TACS 100 and each other over, for example, a Network 13.

Triage Service module 2 may be implemented as one or more computer systems, software processes operating on one or more computers concurrently, and/or database computer systems, etc. Triage Service module 2 may be tasked with supporting a TACS-implemented Triage Service, which generally assists with consumer qualification to purchase a TACS Product, pre- and post-purchase product counseling, physician scheduling, diagnostic test scheduling, product usage compliance coaching, consumer health profiling and profile tracking, pharmacovigilance and other direct customer communications. Communication with Triage module 2 may take any form desired, but preferably includes at least both in-bound and out-bound telephone calls, e-mails and electronic communications over Network 13 between TACS 100 and Consumer 11. Triage Service module 2 may, therefore, be equipped with, for example, a computer server for receiving and transmitting consumer information and enabling interaction with consumers over a Network 13. Alternatively, Triage Service module 2 may be equipped with a computerized automated telephone system that may issue voice commands and receive voice and/or keypad tones, such as dual-tone multi-frequency (DTMF) tones. Other forms of input may be implemented as required.

Triage Service module 2 may also include support sub-components, such as an Electronic Medical and/or Health Records (EMR/EHR) software package or system. EMR/EHR systems enable doctors to write electronic prescriptions (i.e., e-prescribing) and maintain EMR/EHR databases. It is also envisioned that doctors may utilize TACS 100 to order TACs products on behalf of their patients. Sub-components, such as EMR/EHR packages and systems, may be implemented internally in TACS 100 or created using third party solutions and communicatively coupled to TACS 100. Non-local embodiments of EMR/EHR may be interconnected with TACS 100 and Triage Service module 2 (or other TACS 100 components, if desired) over Network 13. EMR/EHR packages generally include a repository of patient information viewable in clinically relevant ways, a workflow tool for patient care process inside an organization, a connectivity tool to exchange information outside the organization, a tool for clinical decision support and population management, and a clinical front-end that is integrated with core back-end billing processes. Such features may enable TACS 100 to provide users with concurrent tracking and documentation of prescription products, TACS products and other non-prescription products.

Available data on a particular consumer's use of any drug, biologic, medical device, diagnostic or genetic test may be stored in an EMR/EHR system and routed automatically to pharmacies and to third-party payment providers (e.g., private or government sponsored medical insurance carriers that make payments to cover all or part of the cost of the health care products for covered individuals). Such data is preferably transmitted over secure network services, such as (but not limited to) an e-prescription network (e.g., Surescripts), thereby enabling two-way data communication between TACS 100, EMR/EHR and all authorized parties. The EMR/EHR package, therefore, preferably assists TACS 100 in tracking and managing TACS purchases, TACS purchase authorizations and a plurality of other related aspects.

The EMR/EHR package may also facilitate the process used by Triage Service module 2 to assess and qualify (or disqualify) purchase of a TACS Product. Given that eventually, virtually all health care providers will utilize EMR/EHR technology and infrastructure, historical prescription data for any individual consumer may be collected by EMR/EHR-enabled Pharmacies and stored on EMR/EHR systems. Therefore, implementation of an EMR/EHR software package or system may facilitate creation of a central repository for consumer prescription history. This may allow Triage Service module 2 to download a consumer's prescription drug and diagnostic test and other health related history through EMR/EHR, regardless of the physician who wrote the prescription, the provider who performed the diagnostic test, whether the drug was prescribed conventionally, or whether it was prescribed through an e-prescription process. EMR/EHR technology may also enable Triage Service based identification, storage and communication of product AE's for pharmacovigilance purposes, tracking drug-drug interactions, etc. This may enable TACS 100 to, for example, determine and/or track the subsequent implications of allowing or disallowing a TACS Product purchase, given other drug or diagnostic test products a TACS consumer may be using. Finally, in embodiments where EMR/EHR is implemented non-locally, TACS 100 (through Triage Service module 2) may require download of a consumer's product usage history to TACS 100 if doing so would improve the performance of TACS 100 or provide better server for the consumer in question.

EMR/EHR programs may present other uses as well. For example, product-billing services may also be managed through such an EMR/EHR package. Diagnostic testing may also benefit from EMR/EHR integration, as diagnostic testing information may be captured and tracked over a series of diagnostic test events for individual users. Information stored in diagnostic testing entity systems, such as a patient's diagnostic history and genetic information, may be coupled to the exemplary EMR/EHR component of Triage Service module 2. This information may be accessed automatically through Network 13 for direct use by Triage Service module 2. EMR/EHR may also be adapted to receive supplemental information from consumers accessing Triage Service module 2. Information from consumers on a variety of topics may aid a Triage Service in addressing a variety of needs, concerns or problems. For example, EMR/EHR acceptance of information related to the use of non-TACS open system, prescription, OTC or BTC products may aid the Triage service in identifying potential AE's or drug-drug interactions.

Order Intake Service module 3 may represent one or more computer systems or software processes associated with taking consumer orders, processing payment and transmitting information to begin order fulfillment. Order Intake Service module 3 may be implemented as one or more computers and/or software processes operating in the framework of TACS 100. Order Intake Service module 3 is preferably adapted to accept order information from a wide variety of formats, including at least telephone orders, electronic orders (e.g., through an online interface, such as (but not limited to) a web page), or in-store (presumably after pre-authorizing the purchase through Triage Service counseling). Other types and/or combinations of formats may be implemented as necessary or as desired, such as standardized mail order forms accompanied by physical or electronic mail order catalogues. Order Intake Service module 3 is also preferably adapted to transmit the order information to the Order Fulfillment & Shipping Service module 4, which is preferably responsible for shipping the product directly to the consumer, or as described further below, to a TACS 100 affiliated secure dispensing location of the consumer's choice for pick-up (such as at a TACS Pharmacy or a TACS automated dispensing machine, either of which may preferably access TACS 100 through Network 13). Information for standing orders for a particular TACS customer may, for example, be stored in a queue in a TACS database. When the TACS product is picked up from the TACS retail location, the order for the person may be designated as completed, and the order information is preferably removed from the queue. During the purchase of a TACS product, Order Intake Service module 3 (and/or Order Fulfillment & Shipping Service module 4) may be tasked with transmitting the purchaser's payment information (e.g., credit card number, bank information, etc.) to the appropriate handler, such as Banking Service module 5.

Order Fulfillment & Shipping Service 4 preferably represents technical systems for implementing back-end logistical support for TACS 100. Order Fulfillment & Shipping Service 4 is preferably tasked with packaging and transporting products directly to TACS product buyers or to TACS retail pick-up destinations (described further below). It may also provide tracking systems for orders, and field help-desk personnel for responding to customer inquiries. Finally, Order Fulfillment & Shipping Service 4 may provide technical documenting and support for warehousing, inventory and other related tasks.

Order Fulfillment & Shipping Service module 4 preferably operates in conjunction with Third Party Shipping Service module 10. Third Party Shipping Service module 10 may represent technical systems and processes operating within third party shipping providers that may be utilized by TACS 100 to deliver products to consumers or to pick-up locations, such as (but not limited to) UPS® or FedEx®. Third Party Shipping Service module 4 may, therefore, represent one or more computer systems and/or processes provided by these third parties for receiving and forwarding customer inquiries, creating order information, managing warehouse inventory and providing shipping and tracking services. Therefore, Third Party Shipping Service module 10 preferably intercommunicates with Order Fulfillment & Shipping Service module 4 to provide TACS Product purchasers with tracking and shipment information.

Banking Service module 5 preferably represents computer systems and processes responsible for processing payments for purchases made through TACS 100. Banking Service module 5 may receive information pertinent to consumer payment, such as (but not limited to) information relating to bank accounts, credit cards, money orders, money wires, cash or any other suitable form of payment. Banking Service module 5 preferably has the ability to utilize this information to draw and deposit funds in a variety of financial systems, including credit card systems, bank accounts, etc., thereby giving Banking Service module 5 the ability to process payments, issue refunds and credits, place funds on temporary authorization hold, etc.

TACS Pharmacy Dispensing module 6A (as described below) preferably represents one or more computer systems and/or software processes associated with the dispensing of products to consumers, if such a distribution is allowed. For example, TACS Pharmacy Dispensing module 6A and Automated TACS Dispensing Machine module 6B (as described below) may constitute computer terminals connected through Network 13 to TACS 100. Although TACS Pharmacy Dispensing module 6A and Automated TACS Dispensing Machine module 6B may be situated in remote locations and may or may not be interconnected themselves, both modules may be considered components of the illustrative embodiment of TACS 100, and have, therefore, been included within the preferred TACS 100 components illustrated in FIG. 1. TACS Pharmacy Dispensing module 6A preferably operates within a pharmacy staffed by pharmacists or other authorized pharmacy store personnel to coordinate and control the secure dispensing of TACS Products to consumers authorized to purchase a TACS Product. In contrast, Automated TACS Dispensing Machine module 6B may be installed in a variety of different locations. Preferably, Automated TACS Dispensing Machine module 6B operate adjacent to or within a retail location. However, they may alternatively be located outside of conventional retail environments, such as (but not limited to) locations situated in close proximity to high pedestrian traffic, thereby enabling high visibility and convenient access to the machine for many people (e.g., in airports, on cruise ships, in train stations, etc.). Both modules 6A and 6B may document and store detailed order information and requirements for dispensing TACS Products, provide access to consumer order information and allow secured and authenticated consumer pick-up of TACS Products from the pharmacy (presumably from behind the counter) or from a secure controlled vending machine that is linked to TACS 100.

In yet another embodiment, Automated TACS Dispensing Machine module 6B may comprise stand-alone vending stations containing pre-filled, pre-packaged and labeled containers of the product (not unlike soda and snack machines). The stations may alternatively contain TACS Product consumption (dosage or usage) units that are automatically counted, filled, packaged and/or labeled by the machine itself (similar to Parata® Systems' automated prescription medication dispensing machines), and subsequently dispensed to consumers in one or more fixed quantities or in quantities chosen by a TACS 100 operator or by the end consumer at the point-of-purchase. The ability to purchase multiple packages and/or large consumption units at one time may be advantageous because it enables various benefits, such as the ability to offer price discounts for larger volume orders, or the ability to purchase product quantities sufficient to last multiple months at one time. However, it should be noted that quantity limitations may be set for individual purchases by the health care company and/or regulatory authority.

In yet another embodiment, the consumer may order the TACS Product directly from the Automated TACS Dispensing Machine module 6B, which may contain a terminal that communicates with Triage Service module 2, Order Intake Service 3 and/or Order Fulfillment Service & Shipping module 4 (or other components of TACS 100). The consumer may choose to have the purchased product shipped by the Order Fulfillment Service & Shipping module 4 to an address of their choosing (preferably the consumer's residence) if, for example, the product is unavailable for pick-up at the Automated TACS dispensing Machine module 6B.

The Automated TACS Dispensing Machine module 6B may utilize a video screen to provide the consumer with information about the TACS Product, and provide a means for the consumer to interact with Triage Service counseling. The machine module 6B may also include a microphone, telephone or other audio communications device that would allow the consumer to speak with a live Triage-based counselor, when desirable. Advertising for TACS Products and/or non-TACS Products may be displayed when the machine module 6B is not being utilized by a TACS consumer.

Additional modules are preferably utilized with TACS 100. For instance, Diagnostician/Clinician module 8 may represent one or more computer systems or software processes operating within a diagnostician or clinician's office or office infrastructure tasked with communicating with TACS 100 over Network 13. Diagnostician/Clinician module 8 may allow a diagnostician/clinician to perform a variety of tasks relevant to TACS 100, such as (but not limited to) approving or disapproving the initial purchase or repeat purchases of products by a consumer who is a patient of the diagnostician/clinician, overseeing the products purchased by a consumer to prevent product misuse, synchronizing consumer/patient information with respect to TACS Products used by patients, sending approval or requests for diagnostic tests, etc. Physician's, optometrists, ophthalmologists, dentists, podiatrists, psychologists, psychotherapists and other authorized diagnostician/clinician professionals may be given access to TACS 100 and its information repositories, thereby allowing them to potentially track and influence which TACS Products their patients may be using.

Diagnostician/Clinician module 8 may be implemented as one or more computer systems or processes operating independently of TACS 100. Diagnostician/Clinician module 8 may interface with TACS 100 via Network 13. Diagnosticians and clinicians may encompass a variety of health care professionals, including (but not limited to) medical doctors, dentists, podiatrists, psychologists, physician's assistants, nurse practitioners, oral healthcare providers and other health care providers who provide similar decision support commonly related to diagnosing and treating and preventing disorders that may result in prescribing or recommending prescription and/or non-prescription drugs, biologics, medical devices and/or genetic or diagnostic test usage. A diagnostician/clinician (or other health care professional) may access a remote Diagnostician/Clinician module 8 by utilizing, for example, an independent computer terminal or other network-enabled device and communicating with Diagnostician/Clinician module 8 over Network 13. Alternative arrangements may be utilized as well. For example, Diagnostician/Clinician module 8 may be built into TACS 100 as a hardware system or software process (or some combination therein). Information pertinent to the Diagnostician/Clinician module 8 may be stored locally within Diagnostician/Clinician module 8. Alternatively, information may be stored remotely on a separate database, or even on a TACS 100 database, in which case, it is preferably remotely accessible over Network 13.

Diagnostic Test module 9 may represent one or more computer systems or software processes that facilitate communication between TACS 100 and diagnostic testing laboratories that conduct health care related tests and procedures. Diagnostic Test module 9 may be implemented as an integrated TACS 100 component accessed remotely by diagnostic facility personnel over Network 13. A diagnostic examination and/or test result based diagnosis may be necessary initially and/or periodically thereafter to ensure proper use of a TACS Product. Diagnostic Test module 9 may, therefore, enable, for example, electronic notification and scheduling of incoming consumer patients and the tests to be conducted, storage and transmission of diagnostic lab test results to the Triage Service, physicians and/or other paramedical personnel (via Triage Service module 2 and/or Diagnostician/Clinician module 8, for instance), and the upload of such information to TACS 100 itself.

In another embodiment, Diagnostic Test module 9 may refer to communicative systems and processes contained within self-testing diagnostic devices. Self-testing diagnostic devices are test devices used to perform health or genetic tests, and can be usually used personally by consumers in their homes. Such devices may include, for example, blood pressure monitors or blood glucose level testers. Preferably, these personal-use Diagnostic Test modules 9 contain communicative systems and processes enabling them to communicate directly with TACS 100 over Network 13 to report the results of a diagnostic test conducted at home by the consumer. Alternatively, consumers may enter test values into TACS 100 manually by accessing consumer module 11.

Consumer module 11 may represent one or more computer systems that facilitate communication between TACS 100 and the consumer over Network 13. Consumer module 11 may, therefore, represent telephones, personal computers, notebook computers, network-enabled televisions, tablets, smart phones and any other suitable device for accessing TACS 100 remotely. These devices may utilize Network 13 to access TACS 100 or sub-components of TACS 100.

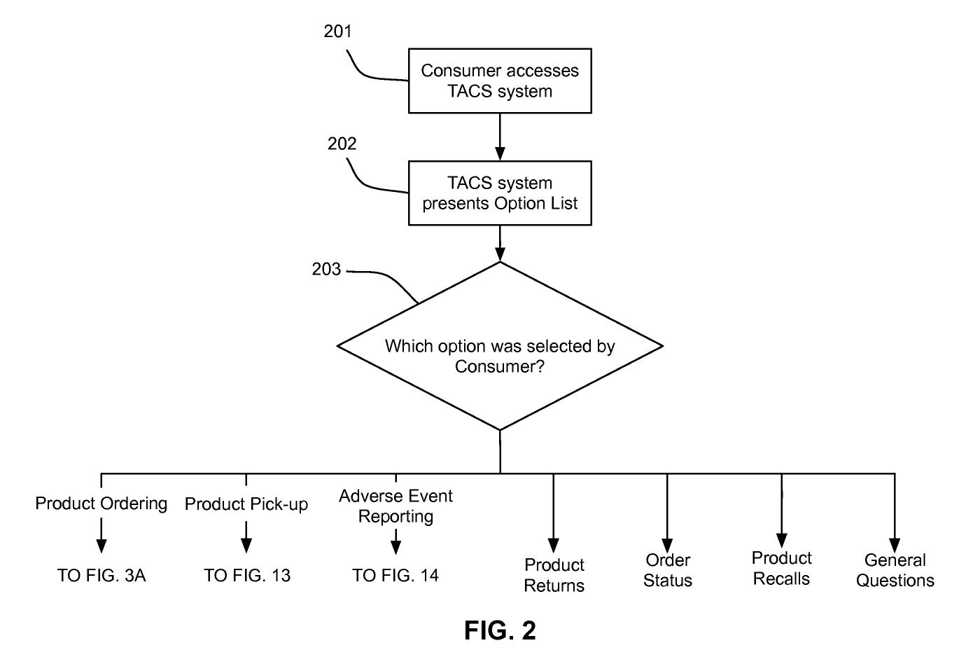

FIG. 2 is a flow chart representing a preferred sequence of steps for implementing TACS 100. In step 201, a consumer who has learned of a product available on TACS 100 may access TACS 100 through Consumer module 11 to initiate purchase of the product by the consumer or by another requesting customer other than the consumer on behalf of, for example, a dependent child or elderly relative, or an animal. It is also envisioned that a treating diagnostician/clinician may order TACS Products on behalf of a patient. In those instances where the requesting customer is not the end user of the TACS Product, it is understood that all health related information utilized by TACS 100 specifically relates to the end user of the TACS Product.

TACS Products may be advertised in a variety of ways, including (but not limited to) all traditional forms of advertisement, such as public broadcast media (e.g., television, radio, etc.), Internet advertisements, e-mail-based mailing lists, physical and digital product catalogues, etc. TACS related personnel and facilities, such as diagnostician/clinicians, physician's offices, hospitals, pharmacies, clinics, stores, etc., may also refer consumers to TACS 100 through advertisements, telephone numbers, internet websites or other locations from which the consumer may purchase a TACS Product. In particular, highly informative advertisements (similar to some infomercials and preferably, more detailed and comprehensive than conventional direct-to-consumer (DTC) advertisements for prescription drugs in the US) may be employed to communicate information about TACS Products, thereby educating consumers about the advantages/disadvantages of using certain TACS Products, helping consumers understand whether they are qualified candidates to purchase the TACS Products, cautioning consumers on which drugs or other products they should avoid when taking a TACS Product, and directing consumers to purchase the product from a TACS center, etc. These marketing efforts, alone or combined with other or related Customer Relationship Management (CRM) vehicles, methods, processes, etc., may help ensure that consumers are better informed about their choices for self diagnosing, self treating, preventing or otherwise self managing certain health issues.

Consumers are preferably given a single TACS account number for each end user of the TACS Product, which is used for all subsequent TACS activities, including purchasing, delivery/pick-up, adverse event reporting, product returns, order status checking, general inquiries, etc. The TACS account number may serve as a unique TACS identifier for that consumer or end user, and all information stored relating to the consumer or end user may be associated with the TACS account number. The TACS account number may be assigned (or selected) upon the consumer's first use of TACS 100.

TACS 100 may be accessed in a variety of ways. TACS 100 preferably has a website presence on the global Internet, not unlike many online retailers. A front-end website or specialized digital interface may be provided for interaction with the consumer, backed by a database that stores relevant Health Insurance Portability and Accountability Act (HIPAA) compliant information about the TACS Consumer (e.g., a health history) and product information, including available inventory, associated purchasing requirements, current available stocks and prices, etc. Digitized graphical information, such as barcodes and digital imprints may also be utilized to deliver general or special information on TACS Products to consumers who have the means to read them. Such digitized graphical information may be delivered to Consumer module 11 over Network 13.

The database also preferably contains user information, including basic identifiers such as name, address and other identification. Additional features may be added to increase the level of consumer-identification security. These features may encompass special identifiers, such as biometrics, alphanumeric codes, graphical codes, social security numbers, insurance identification, etc.

The consumer or requesting customer may access the web-based interface through Network 13 via Consumer module 11, which may represent (as described above) some network-enabled computerized device (e.g., the consumer's personal computer, a “smart” phone, hand-held computing device, etc.). Consumers may also access TACS 100 through other means, such as retail terminals (e.g., computer terminals located inside a retail pharmacies, food stores or even airports, train stations, other venues, etc.). Other alternative access methods may be implemented as desired. Automated TACS Dispensing Machines 6B may also provide means for accessing TACS 100. As described above, the Automated TACS Dispensing Machine 6B may contain display and communication systems that enable full functionality for the TACS functions (described below).

The consumer may also access TACS 100 through a telephone, and issue commands to TACS 100 via Dual-Tone Multi Frequency (DTMF) tone input or voice command. A toll free or paid telephone number may be provided for this purpose. TACS 100 may communicate with the consumer via, for example, interactive computer program, interactive voice response (IVR) programs, etc. In yet another embodiment, TACS 100 may be accessed through direct mail order. Catalogues, fill-forms and other materials may be provided to enable communication with TACS 100 via standard mail. Other methods, such as interactive networked television menus, interactive kiosk-mounted computers, etc. may also be implemented as desired to permit the consumer to access TACS 100.

In step 202, TACS 100 may present the consumer with options. These options preferably correspond to the functions performed by TACS 100, and may comprise (at least) TACS Product Ordering, TACS AE Reporting, TACS Product Returns, TACS Order Fulfillment Status Inquiries, TACS Product Recall Information and General Questions. These options may be presented, for example, via display on a computer display, if a consumer is accessing TACS 100 from a remote terminal. Alternatively, these options may be communicated by automated voice if the consumer is accessing TACS 100 by phone. TACS 100 may then determine, in step 203, which option was selected based on the input supplied by the consumer.

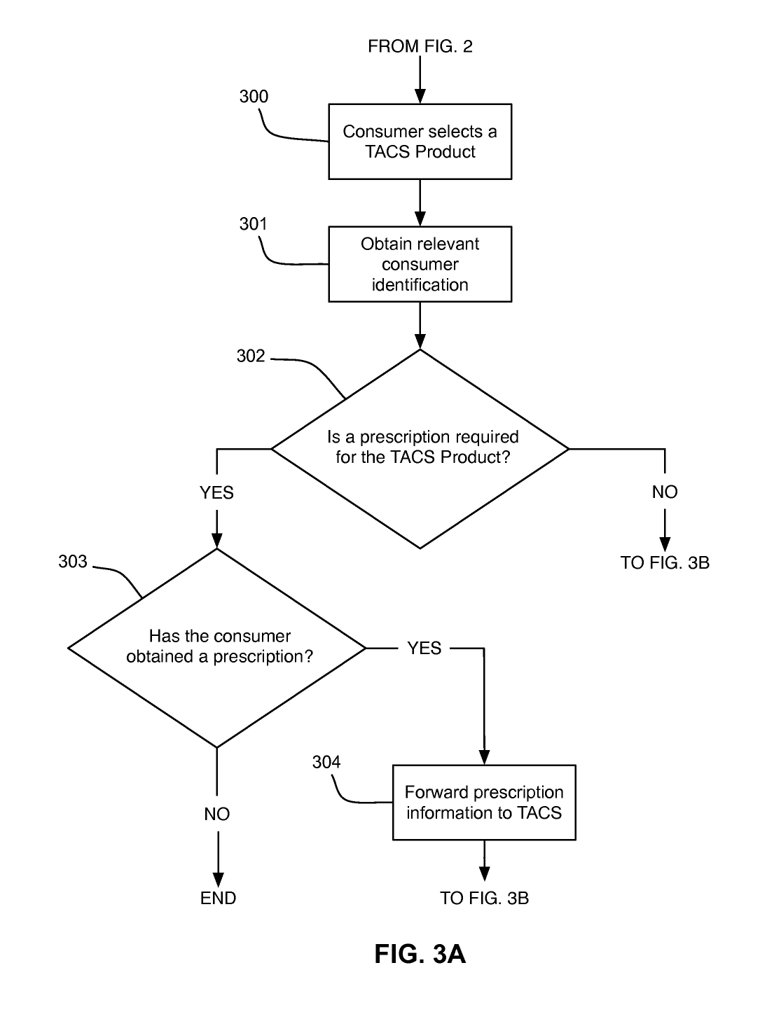

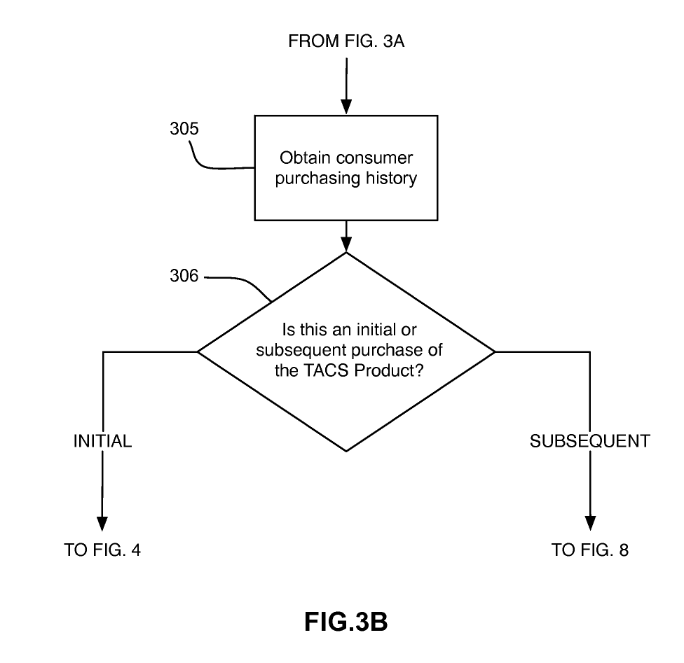

FIG. 3 is a flow chart representing a continued preferred sequence of steps for implementing TACS 100, if the consumer selected Product Ordering from the TACS 100 options. In step 300, the TACS ordering process may be initiated when the consumer selects a TACS Product for purchase. If TACS 100 is being accessed from a remote computer terminal, the consumer is preferably provided with a graphics and text based display that allows the consumer to select one or more TACS Products. TACS Products may be organized into categories (preferably utilizing a back-end database) to enable faster and more efficient searching, as typical of many modern day online retailers. A search algorithm may also be provided, enabling the consumer to search by name, category, ailment and any other factor or descriptor that will aid the consumer in finding the desired TACS Product.

If TACS 100 is being accessed through a phone interface, voice commands and DTMF tones are preferably utilized to navigate the menu. Because the system would lack a visual interface, information may be read aloud to the consumer (for example, through IVR utilizing voice or DTMF commands). As mentioned above, a physical TACS Product catalog may be provided to the consumer as well. The TACS Product catalog may comprise different variants for different consumers. For example, a primary product catalog may contain a substantially full list of available TACS Products. Alternatively, a targeted product catalog may be issued uniquely to specific consumers, and list only those products for which the consumer is currently authorized to purchase. TACS Product catalogs may be mailed to the consumer on request, or stocked, for example, in pharmacies, physician's offices, clinics, etc. TACS Products may be identified in the catalogue via an identifier, such as a product code. The identifier may then be utilized to select a product on TACS 100, preferably across all TACS 100 input methods (e.g., global product network internet site, text messaging, DTMF input and/or other controlled electronic means during ordering, etc.).

In step 301, TACS 100 preferably identifies the consumer. Identification of the consumer may occur before or after the consumer has selected a TACS Product for purchase (similar to the manner in which many online retailers function). Identification may be performed through a TACS-provided code or identifier if the consumer is already a registered TACS purchaser. Alternatively, the information may be retrieved automatically from TACS 100 data storage based on some identifying token provided by the consumer or on behalf of the end user of the TACS Product. This token may include, for example, biometric information (such as a retina or fingerprint scan), identifying codes (such as a social security number, driver's license, etc.), or even something as simple as a TACS user name and password. If the consumer is not already a registered TACS purchaser, TACS 100 may present options allowing the consumer to register with TACS 100, preferably requesting basic information, such as name, address and phone number. Other forms of information may be requested as well. The registration process may be conducted through an Internet website, over telephone or through a manual fill-out and mail-in form. Registration may also be performed on behalf of the consumer at health care provider facilities, such as hospitals, diagnostician/clinician facilities, etc.

In step 302, TACS 100 (through Triage Service module 2) preferably determines if the desired TACS Product requires a prescription for purchase. Some TACS Products may still require a prescription for purchase despite being available on a non-prescription basis since a diagnostician may first need to determine what particular product strength, type or characteristic is appropriate to treat, manage or prevent a particular disorder. Thereafter, the consumer may purchase the TACS product on a non-prescription basis until such time that a revised prescription may be required. Examples of such products may include insulin and syringes. Contact lenses may also be included, as an example, if a regulatory authority permits a classification switch to a non-prescription TACS classification (in accordance with this disclosure). If the TACS Product requires a prescription for sale, the process may proceed to step 303. If the TACS Product does not require a prescription for sale, the process may instead progress directly to FIG. 3B. In step 303, TACS 100 may determine whether or not the consumer has obtained a prescription. If the consumer has not obtained a prescription, then the process may end and the consumer may be denied authorization to purchase the TACS Product until they obtain a valid prescription. Alternatively, if the consumer has obtained a prescription, then, in step 304, the prescription information is preferably forwarded to TACS 100, and the process may progress to FIG. 3B.

Certain rules and limitations may be imposed on these process steps. For example, if contact lenses are switched from prescription to non-prescription status (due to the adoption of a TACS protocol), certain current legal restrictions may be levied against the sale of contact lenses on TACS. For example, the Fairness to Contact Lens Consumers Act (FCLCA) promulgates certain rules for prescribers, requiring them to supply patients with a copy of their contact lens prescription(s) at the end of a contact lens fitting, even if the patient has not requested it.

FCLCA also stipulates that the prescription cannot be filled unless the seller has either received a copy of the prescription or has verified the prescription as required by the Act. Time constraints are also imposed, as the prescription cannot be filled if the prescriber tells the seller that the prescription is inaccurate, expired, or otherwise invalid by “direct communication” within “eight-business-hours” after receiving the complete verification request. “Direct communication” by telephone (with respect to TACS 100) may require reaching and speaking with a TACS Triage Service provider or Prescriber recipient as the case may be, or leaving a voice message on a telephone answering machine of the intended recipient. “Direct communication” by facsimile or electronic mail requires that the intended recipient actually receive the facsimile or electronic mail message.

TACS 100 may, therefore, be required to comply with the requirements of the Act if it were to sell non-prescription classed contact lenses. In accordance with the FCLCA, Triage Service module 2 may be tasked with sending a verification request to the prescriber electronically by telephone, facsimile or electronic mail, or through other legally suitable means. An exemplary TACS contact lens ordering and verification process may function as follows. First, the consumer may send contact lens prescription information to Triage Service module 2 in the form of a facsimile or as an electronically e-mailed secure scanned image of the prescription. If a prescription is not submitted to Triage for TACS approved contact lenses, Triage Service module 2 may deny sale authorization until a valid prescription is secured from an authorized provider. Second, Triage service module 2 may then submit the prescription to the prescriber in the form of a verification request. Third, the prescriber has eight-business-hours to respond, in accordance with the FCLCA. If the prescriber does not respond within the required time, then the prescription may be verified automatically, thereby allowing Triage-based authorization of the sale of contact lenses to the consumer. If the prescriber responds in the required time and approves the verification request, then the Triage service may directly authorize the sale of contact lenses to the consumer. However, if the prescriber denies the verification request, Triage Service module 2, may deny sale authorization until a valid prescription is secured from an authorized provider.

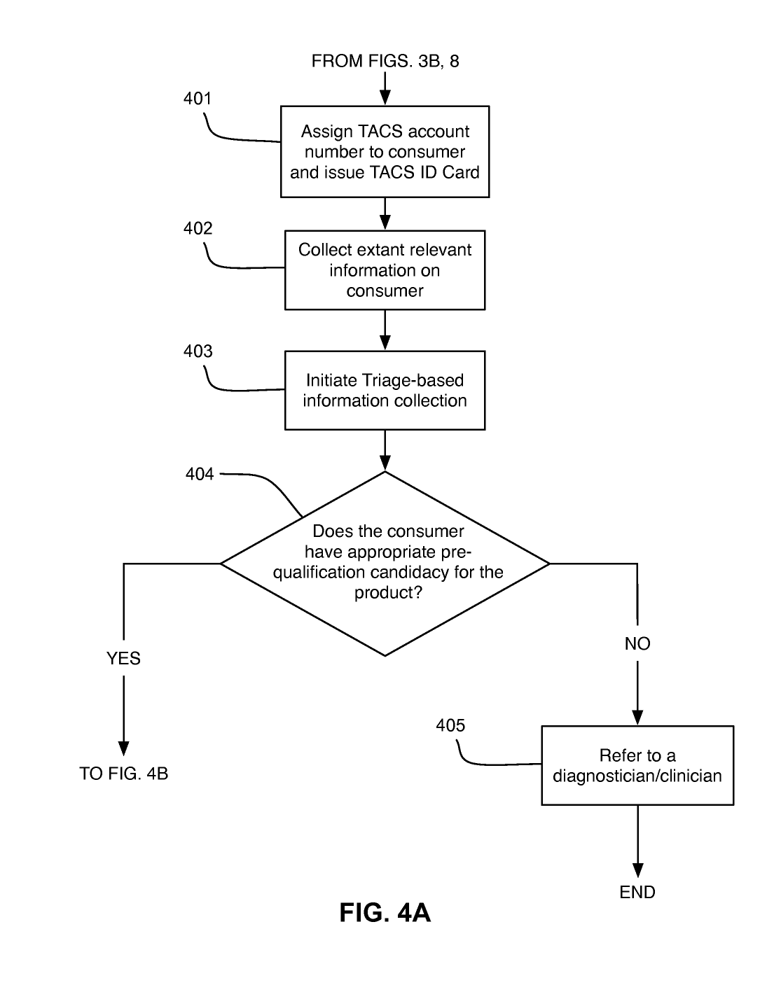

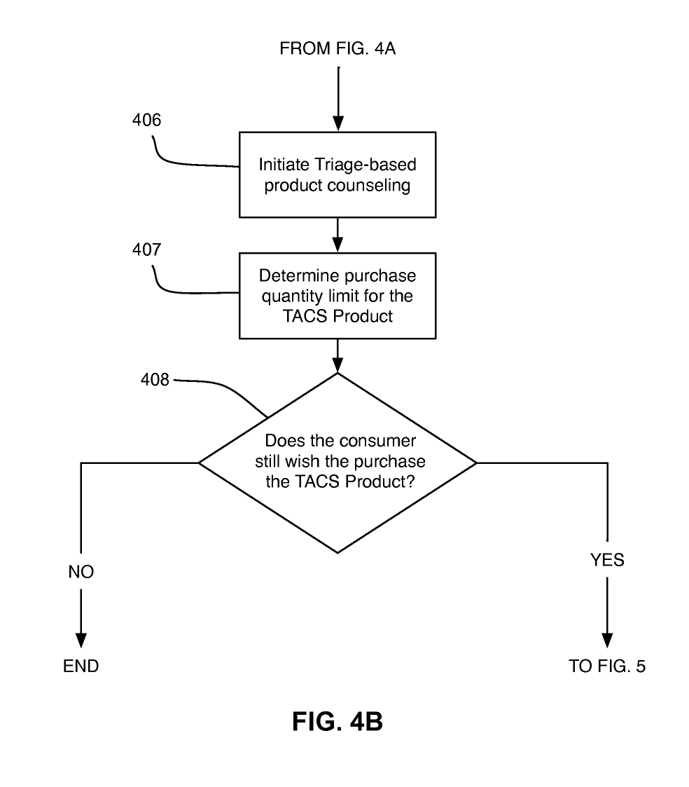

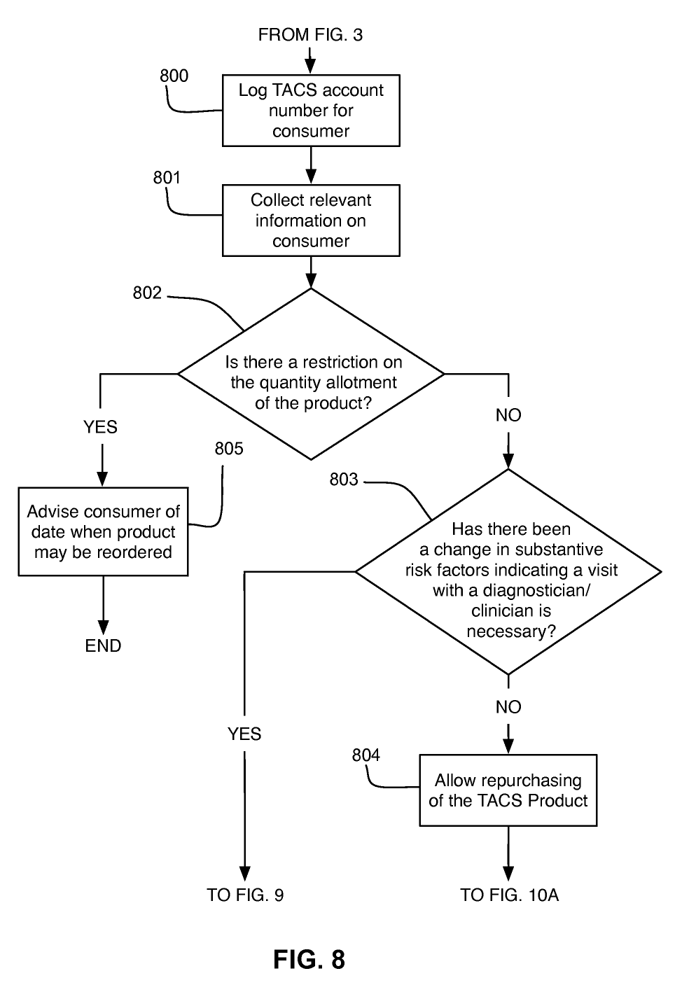

FIG. 3B is a flow chart representing a continued preferred sequence of steps for implementing TACS 100. In step 305, based on the available consumer identification information, TACS 100 preferably obtains the consumer's purchasing history. The consumer's TACS purchase history is preferably stored on a TACS 100 or TACS 100 related database (such as the EMR/EHR package system described above) and associated with consumer identification information. Once the consumer's identification is retrieved, TACS 100 may retrieve the consumer's TACS purchase history. In step 306, TACS 100 preferably determines, based on the consumer's purchase history, whether the current purchase is an initial purchase of a TACS Product or a subsequent purchase of a TACS Product. TACS 100 may accomplish this step by algorithmically comparing the current to-be-purchased TACS Product to the consumer's purchase history. Alternatively, TACS 100 may simply query the consumer to indicate whether the current purchase is an initial purchase or a subsequent purchase. If no match is found, the current purchase may be deemed an “initial” purchase, and the process may proceed to FIG. 4. If a match is found, then the current purchase may be deemed a “subsequent” purchase, and the process may proceed to FIG. 8.

FIG. 4A is a flow chart representing a continued preferred sequence of steps for implementing TACS 100 when it is determined that a current purchase is an initial purchase. Each TACS Product preferably has a guideline algorithm that determines consumer eligibility for purchase. The guideline algorithm may take into account a variety of health risk factors related to the use of the product by the consumer, such as (but not limited to) age, race, gender, weight, personal medical history including (but not limited to) current prescription and non-prescription drug usage and current or past medical conditions, family medical history, the presence of one or more physical, genetic or biologic pre-existing conditions, health-effecting personal habits (e.g., cigarette or alcohol use), etc. A specific list may be set, for example, by the Health Care Product Company in accordance with guidelines approved by a regulatory authority for a particular TACS Product.

In step 401, a TACS account number is preferably assigned to the individual for whom the product is being purchased. Tying account numbers to social security number, date of birth and home address may help ensure that the person supplying the TACS number is the person for whom the account was established. A unique TACS identification card or personal identification code (TACS ID) may be provided to the consumer at this time as well. The TACS ID is preferably used to track all subsequent TACS activity undertaken by the consumer.

In step 402, TACS 100 may initiate collection of already extant relevant consumer information that is necessary to make an algorithmic determination of purchasing eligibility. TACS 100 may determine what information is required based on the guideline algorithm for the specific product to be purchased. TACS 100 may then retrieve the relevant information for the current consumer from a TACS data storage system, if any information exists.

It is anticipated that, oftentimes, some or all of the information necessary to make an algorithmic determination of eligibility will not be retrievable from TACS 100 EMR/EHR systems. Therefore, in step 403, TACS 100 may initiate Triage Service-enabled information collection. Triage-based information collection may be executed by Triage Service module 2. For many products and consumers, the information to be collected may be very simple. This may enable the use of a computer program to assist in its capture. Therefore, Triage Service module 2 may collect the pertinent information from the consumer utilizing media (e.g., interactive websites, interrogatory voice programs, etc.) that presents the users with questions and stores the subsequent answers. This may be presented to the consumer in a variety of ways, depending on the format of the media. For example, interactive websites may be presented to the consumer over Network 13 onto a personal computer, smart phone, or tablet, etc. Similarly, interrogatory voice programs may question the consumer over the telephone. For more difficult information (or for more challenged consumers), live human Triage representatives may interact directly with consumers to obtain the necessary information. In any case, consumer responses (which would also be dependent on the format of the media) may then be interpreted, associated with the consumer and stored in TACS 100.

In step 404, TACS 100 preferably determines whether the consumer has the appropriate pre-qualification candidacy for the desired TACS Product. A pre-qualification algorithm may determine whether the consumer has appropriate candidacy for the TACS Product based on the information collected in steps 402 and 403. Naturally, individual TACS Products are directed towards treating, preventing or diagnosing specific illnesses, disorders or for alleviating symptoms. Consumers who lack the appropriate condition or lack the likelihood to develop the condition have little legitimate reason to purchase the TACS Product. Therefore, the pre-qualification algorithm may serve as a basic screening process to ensure that the consumer is an appropriate candidate to receive the TACS Product, and that the consumer is purchasing the TACS Product for medically legitimate reasons. The pre-qualification algorithm may be supplemented by a TACS Product sale algorithm that determines product sale authorization based on more in-depth information (which is described further below).

If the consumer does not have appropriate pre-qualification candidacy for the TACS Product, then, in step 405, the consumer is preferably referred to a diagnostician/clinician for counseling and treatment of whatever malady the consumer may be concerned about, and the TACS process may end. Alternatively, if it is determined in step 404 that the consumer does have appropriate pre-qualification candidacy for the TACS Product, then the process may progress to FIG. 4B.

FIG. 4B is a flow chart representing a continued preferred sequence of steps for implementing TACS 100 after it is determined that the consumer possesses appropriate pre-qualification candidacy for the TACS Product. In step 406, TACS 100 may initiate a Triage-enabled product counseling session. Counseling sessions may be conducted to educate consumers on a variety of topics related to the product being purchased. The topics may include proper usage of the product, general product warnings, benefits of the product, risks associated with the product, or specific warnings on use of the product, such as drug-drug interactions, negative side effects or consumer-based risk factors (e.g., dangers due to age, race, physical or genetic characteristics). The actual topics to be covered and content contained therein may be determined by, for example, the product manufacturer and/or regulatory authority. The counseling session, like Triage-based information collection, may utilize a variety of formats according to need. For example, if the consumer is accessing TACS 100 via a computer, the counseling session may take the format of an audio voiceover, a video multimedia presentation, or even something as simple as a readable text displayed on the consumer's computer screen. Alternatively, if the consumer is accessing TACS 100 via telephone, counseling may be limited to audio voiceover. In some instances, a live Triage representative may perform counseling. This may be advantageous in situations where the purchaser prefers discussing a particular TACS Product with a live person or if, for example, the consumer has special needs, or where warnings and use of the product are particularly complex or potentially dangerous if the product is not used correctly.

TACS Product information relayed to or discussed with consumers is preferably scripted to ensure adherence to specific key communication points and health management algorithms. For example, Triage Service module 2 may provide (but is not limited to) the following services:
assess the candidacy of the consumer to receive the TACS Product;
educate the consumer regarding the appropriate use of the TACS Product;
educate the consumer on the relative health benefits and risks associated with using the TACS Product;
capture and document consumer “informed consent” as a prerequisite to being allowed to purchase the TACS Product;
capture and document a list of factors, such as age, gender, lifestyle habits, diagnostic test results, hereditary risks, prior physician diagnosis, drug history, etc., for particular disease states, documented disorders or potential disorders;
capture and document consumer-provided list of prescription, OTC, BTC and TACS Products (such as drugs, biologics and medical devices, or diagnostic and genetic testing kits) currently being used by that consumer;
capture and document a complete drug usage history, which may comprise a list of previously filled prescriptions for a particular consumer at pharmacies or similar vendors (whose records can preferably be automatically downloaded to Triage Service module 2 through Network 13 utilizing specialized internet conduits, such as those offered in the United States through an e-prescription network);
capture and document a liability waiver for utilizing the TACS Product, including disclaimers (such as having had a physician consultation if required before utilizing the product);
capture and document whether a physician's prior diagnosis has been obtained for the condition for which the TACS Product is approved to treat;
capture and document a list of clinical symptoms currently being experienced by the consumer which may or may not be traceable to the TACS Product, and notifying the consumer if symptoms indicate that the intervention of a physician is required;
provide clinical decision support for drug interactions and allergies;
capture and document a trending analysis of diagnostic test findings;
provide preventive care protocols and reminders based on, for example, symptoms, prior medical diagnosis and self-reported medication;
secure and structure communication between diagnosticians/clinicians, Triage Service computerized algorithms and/or Triage Service counselors and the consumer;
issue TACS product compliance reminders;
capture and document (or support) pharmacovigilance reporting; and
provide consumer outreach services (automated or otherwise) for preventative care and/or chronic disease/disorder/marginal health management.

In step 407, a sales quantity allotment minimum and/or maximum quantity may be retrieved by Triage Service module 2 (in accordance with regulatory requirements) for the TACS Product being purchased. Initial distributions of a TACS Product may be limited by quantity limits as determined by Health Care Product Companies or by Regulatory Authorities. TACS consumers are preferably restricted from purchasing more than these set quantity limits.

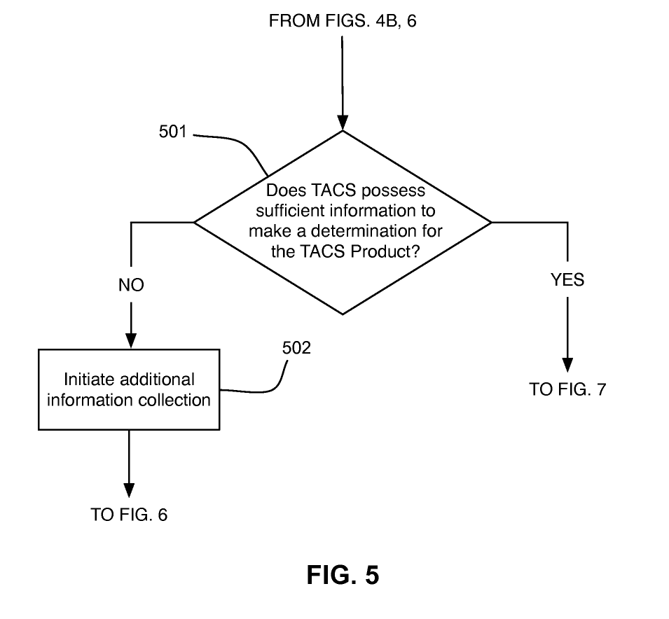

In step 408, TACS 100 (through Triage Service module 2) may determine whether the consumer still wishes to purchase the TACS Product. This may be accomplished by means of a simple prompt or query. The consumer preferably answers affirmatively or negatively. If the consumer answers negatively, the TACS Product purchasing process may end. However, if the consumer answers positively in step 408, the process preferably proceeds to FIG. 5.

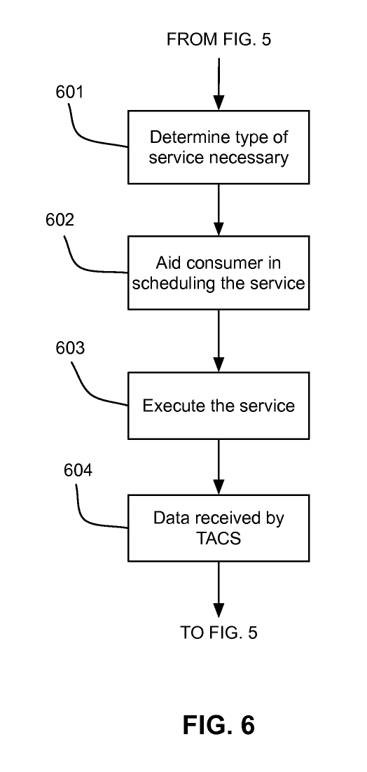

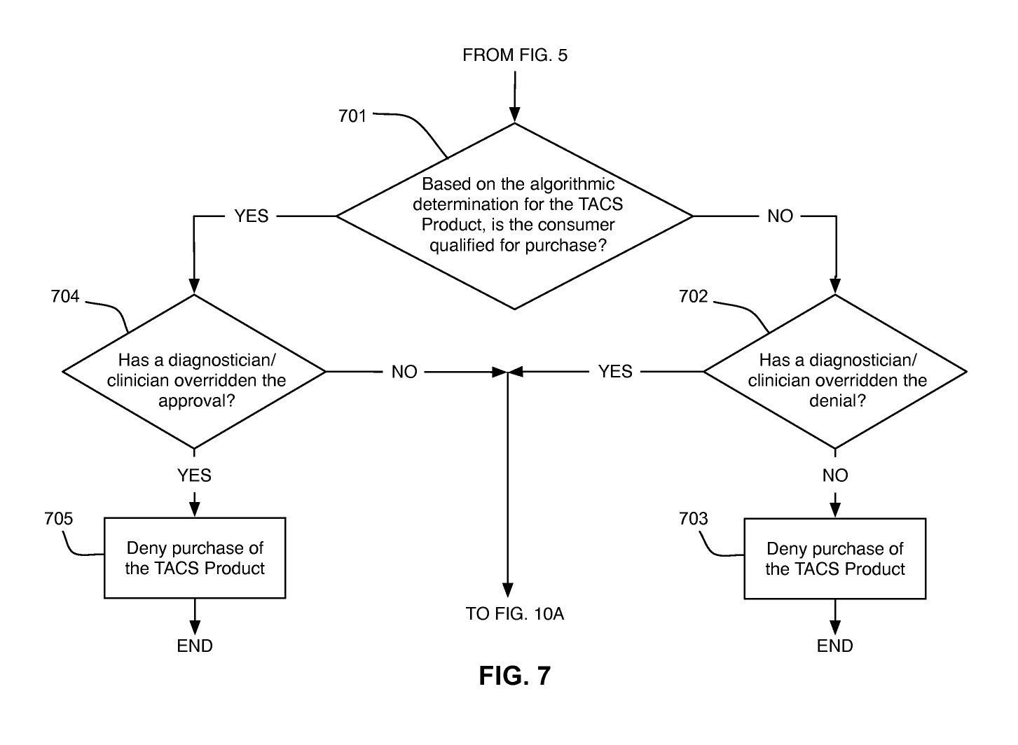

FIG. 5 is a flow chart representing a continued preferred sequence of steps for implementing TACS 100. In step 501, TACS 100 preferably determines whether it has sufficient information to make an algorithmic determination of eligibility to purchase the TACS Product. Oftentimes, the information collected in steps 402 and 403 (FIG. 4A) may be insufficient for the algorithm to determine whether the TACS Product may be authorized for sale to the consumer. For example, with respect to the exemplary requirements for authorization of sale of drugs commonly known as “statins” (HMG-CoA reductase inhibitors), an additional risk factor may be imposed where people with certain health profiles having a fasting LDL-Cholesterol level over a certain threshold may be denied authorization to purchase the TACS statin product, because a diagnostician/clinician's assessment may be required for more appropriate treatment of the individual than the treatment the individual would receive from merely taking the TACS statin product. However, the current LDL-Cholesterol level of a consumer may be unavailable absent diagnostic testing. Therefore, more intensive additional procedures may need to be undertaken before TACS 100 can make an algorithmic authorization determination. If TACS 100 determines in step 501 that it has sufficient information to make an algorithmic authorization determination, then the process may proceed to FIG. 7. If, however, TACS 100 determines that it does not have sufficient information to make an algorithmic authorization determination, then in step 502, TACS 100 may initiate a process for collecting additional information, and progress to FIG. 6.

FIG. 6 is a flow chart representing a continued preferred sequence of steps for implementing TACS 100 in the event that TACS 100 determines that additional information collection is required before a determination may be made on whether a TACS Product should be authorized for sale to a consumer. In step 601, TACS 100 preferably determines what type of service needs to be conducted to obtain the additional information. Naturally, certain types of information are available through specific forms of service. For example, LDL-Cholesterol levels are typically determined from a blood test (sometimes after a period of enforced fasting). Therefore, for the initial sale of a TACS statin product, a blood test may be required including a lipid panel screen to set a baseline level of Triglycerides, LDL and cholesterol. Because liver problems may develop without symptoms, people who take statins should have a hepatic function panel blood test six weeks after starting a statin medication to check their liver function. After that is completed, annual blood tests may be sufficient.

Other types of information may require other types of services. For example, a form of diagnostic testing may be required, which may comprise tests performed by the consumer at home, tests conducted by health care professionals at the consumer's home, tests conducted by health care professionals at a diagnostician/clinician's office, or even tests conducted at diagnostic facilities with specialized equipment (such as a magnetic resonance imaging system). Alternatively, a follow-on check-up and/or discussion with a diagnostician/clinician may be required.

Once TACS 100 has determined which service is necessary, then, in step 602, TACS 100 may optionally aid the consumer in scheduling the service. Notification to the consumer that a test is required may be sent, for example, via an e-mail authorization, a fax communication, a written/printed mailed letter, real-time notification on a website or kiosk display, a telephone call, telephone text message, etc. Any suitable communications format may be utilized as required.

Additionally, scheduling may be implemented in a number of ways. The process may be fully automated. For example, TACS 100 may communicate automatically with Diagnostic Test module 9 through Network 13, and retrieve a set of open time slots for an appointment. TACS 100 may then display these available time slots to the consumer. Once the consumer selects an available time slot, TACS 100 may reserve that time slot for the consumer by, for example, transmitting the consumer's selection to the Diagnostic Test module 9 over Network 13. Alternatively, a traditional scheduling scheme may be implemented. For example, TACS 100 may simply notify the consumer that a diagnostic test is required. The consumer would then be responsible for finding a qualified diagnostic center, scheduling an appointment, having the test completed and ensuring that the test results are received by TACS 100. Mixed solutions are also contemplated. For example, scheduling may be performed manually, but the test results may be automatically uploaded to a Diagnostic Test module 9. Alternatively, scheduling may be performed automatically, but TACS 100 may receive diagnostic test results through standard mail or, alternatively, the consumer may enter diagnostic test results themselves into TACS 100 through Consumer module 11. Multiple solutions may be employed uniquely, uniformly, or as a mixed system.

Identifying information, such as the consumer's name, date of birth, address, driver's license number, and/or social security number, etc., may be provided to the Diagnostic Test module 9 to aid scheduling and performing the test. Other types of unique identifiers may be assigned to the consumer as well.

In step 603, the service may be executed to obtain the necessary information. The consumer may execute self-administered tests, subject himself to tests conducted by health care professionals at the consumer's home, undergo tests conducted by health care professionals at a diagnostician/clinician's office, or be examined at a diagnostic facility with specialized equipment. In step 604, TACS 100 may receive the test result data. For diagnostic tests conducted at a diagnostician/clinician's office or at a designated diagnostic facility, health care professionals or automated processes at the diagnostic center preferably analyze the sample and upload the results of the diagnostic test into the Diagnostic Test module 9. In situations where interpretations of the diagnostic test results are simple, TACS 100 may determine automatically from the uploaded data whether the diagnostic test results satisfy the requirements for purchasing the TACS Product. More complex diagnostic tests may require interpretation from diagnostic facility personnel, or even outside third parties, such as the consumer's physician. In still other instances, the diagnostic test reading, though complex, may be modified either by the diagnostic test provider, by the Health Care Product Company, by TACS 100 or by a third party (and preferably approved by a regulatory authority), for example, to two or more general classifications such as (but not limited to): “Normal/Abnormal,” or “Normal/Abnormal High/Abnormal/Low.” In these situations, the results of the analysis (rather than the diagnostic test results alone) may be uploaded to TACS 100 by, for example, Diagnostic Test module 9. Alternatively, through an approved algorithm, TACS 100 may convert the raw test data into more general classifications that can more easily be interpreted by Triage Service module 2.

For diagnostic tests administered in the consumer's home (whether by the consumer or by a health care professional), electronic data entry equipment may be used to capture diagnostic information and upload the information to TACS 100 via Network 13. Other means of analyzing and transmitting the diagnostic test results to TACS 100 may be implemented as required. For example, the self-diagnostic testing device may transmit the diagnostic test results directly to TACS 100. For example, the device may contain communication technology, such as a wired or wireless network connection. The device may, therefore, automatically upload results to TACS 100 through Network 13. Alternatively, a storage device, such as a universal serial bus memory stick, may be removable from the device. Data may then be transferred to a personal computing terminal, and information may be uploaded to TACS 100 through Network 13. In yet another embodiment, consumers may manually input the data into their personal computer through Consumer module 11. A confirmation may be required, forcing the consumer to certify that the data is correct and true. The consumer may then be allowed to upload the data to TACS 100 through Network 13. Other types of special software and/or hardware may be used to upload the results of diagnostic testing direct to TACS 100 or to a terminal connected to Network 13. TACS 100 may also receive diagnostic results performed by the consumer from alternate sources. For example, data may also be sent via telephone network (by text message, for example) or verbally related to a Triage Service representative.

Subsequently, the process may return to FIG. 5, where, in step 501, TACS 100 may again determine whether it possess sufficient information to make an algorithmic authorization determination for the present consumer and current TACS Product.

FIG. 7 is a flow chart representing a continued preferred sequence of steps for implementing TACS 100 after it determines that sufficient information exists to make an algorithmic authorization determination. In step 701, TACS 100 may execute the algorithmic authorization determination for the current TACS Product and the current consumer. The algorithm may analyze the set of health risk factors associated with the TACS Product to be purchased and determine, based on the information collected in the steps above, whether the consumer falls within an acceptable threshold for authorization based on the risk factors for the TACS Product.

For example, an algorithm for considering the eligibility of a consumer for purchasing a cholesterol-lowering statin may consider a number of risk factors. Primary consideration risk factors may include (but are not limited to) age, weight, gender, health-effecting personal habits (such as drinking alcohol or smoking), personal and family medical history, obesity, race, and/or the presence of one or more physical, genetic or biologic pre-existing conditions. In one embodiment, for example, the algorithm may dictate that the statin TACS Product may be appropriate for sale through TACS 100 for individuals with moderate risk of Coronary Heart Disease (CHD). Individuals with moderate risk of CHD may be defined to include men between the age of 45-54 and women of age 55-70 having one or more pre-identified risk factors, and men aged 55 to 70 with or without any listed risk factors. The listed risk factors may also include whether the consumer is currently a smoker or was a smoker during the last four years, and whether the consumer's family has a history of heart disease (e.g., a father or brother had a diagnosed heart attack or diagnosed angina before age 55, or a mother or sister had a diagnosed heart attack or diagnosed angina before age 65), whether the consumer is obese (defined by waist measurement and/or Body Mass Index (BMI) indicators, which may be calculated by the TACS 100 algorithm for the statin TACS Product), and whether the consumer has a South Asian family origin (e.g., India, Pakistan, Bangladesh or Sri Lanka). The presence of one or more of these factors (in combination with the age and gender information) may determine algorithmically whether the consumer will be authorized to purchase the statin TACS Product. For example, if none of these categories apply, the statin TACS Product may not be suitable to treat the condition since the individual may be at a low risk or no risk of CHD. In such instances, TACS Triage Service may provide counseling on lifestyle modifications for the individual to reduce the future risk of CHD.

Even if the authorization criteria are met, certain people may still be referred to a medical doctor. The algorithm may list factors indicating such referral as well. For example, a family history of diabetes, angina, previous heart attacks, previous strokes, hypertension, abnormal liver function, hyperthyroidism, renal impairment and/or other muscular disorders may be barred from purchasing the statin TACS Product. Women who are pregnant or breastfeeding may also be denied authorization. Secondary habits may be considered as well, such as a consumption of a certain quantity of alcohol per day, or whether the consumer is a smoker.

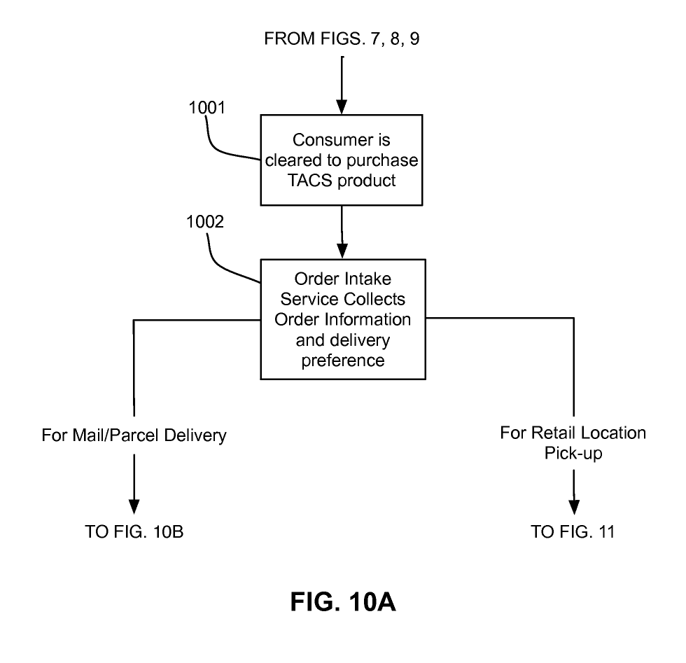

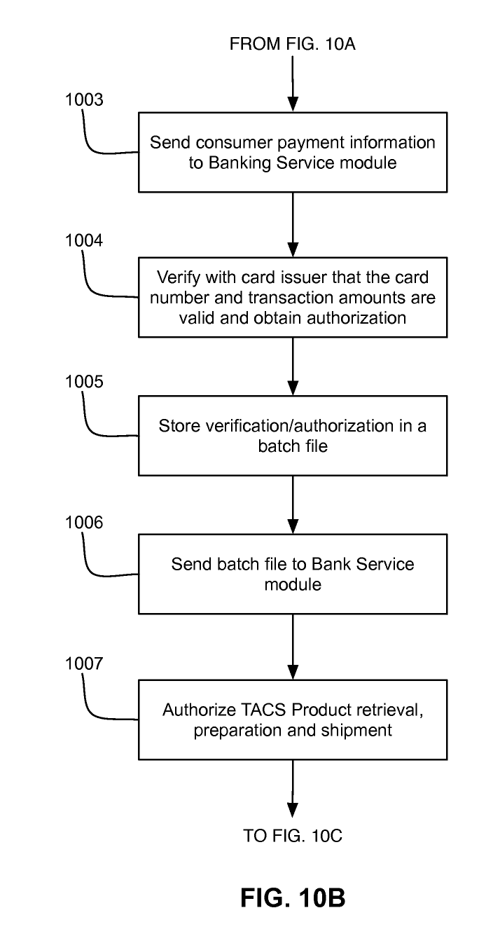

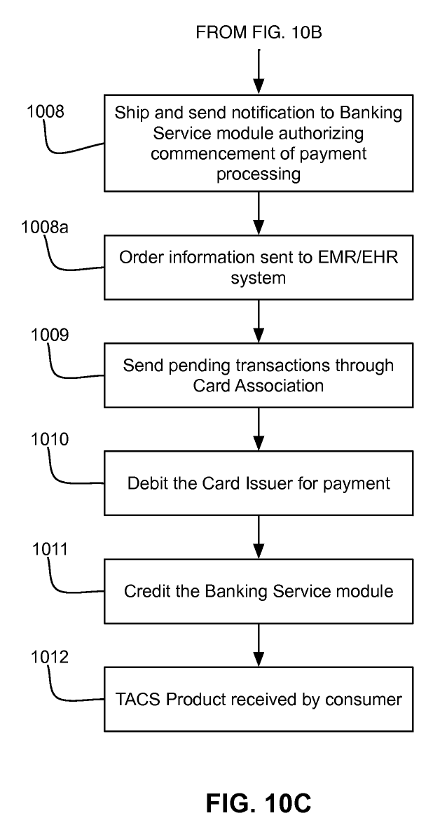

If the algorithm performed by TACS 100 determines that the consumer is authorized to purchase the TACS Product, then the process may proceed to FIG. 10A (subject to a diagnostician/clinician override discussed below). If the algorithm performed by TACS 100 determines that the consumer is not authorized to purchase the TACS Product, then in step 702, TACS 100 may await overriding authorization from a health care diagnostician/clinician. It is anticipated that diagnosticians/clinicians may sometimes authorize their patients to utilize health care products and drugs even though TACS 100 has declined purchase authorization, because diagnosticians/clinicians may gain more nuanced and detailed understandings of their patients' conditions compared to the more rigid risk factor analysis considered by TACS 100. Therefore, TACS 100 preferably includes a mechanism that allows a diagnostician/clinician to override the TACS 100 algorithmic authorization determination. If such an override is provided, TACS 100 may authorize the sale of the TACS Product to the consumer and the process may proceed to FIG. 10A. If an override is not provided, then in step 703, the consumer is denied purchasing authorization and the process may end.

Similarly, diagnosticians/clinicians may override purchasing authorization as well, as it is anticipated that diagnosticians/clinicians may want to prohibit their patients from receiving certain TACS products (like statins in the above example) even though TACS 100 determined that consumer would be authorized to purchase and use the TACS Product. Therefore, in step 704, if TACS 100 receives a diagnostician/physician override for a TACS Product purchasing authorization, then, in step 705, TACS 100 may revoke purchasing authorization for the TACS Product. If TACS 100 does not receive a diagnostician/physician override for a TACS Product purchasing authorization, then the process may proceed to FIG. 10A. A waiting period of some quantity may be imposed on certain TACS Products to create a sufficient window of time for a diagnostician/clinician to be notified of the sale, and determine if they wish to override the TACS purchasing authorization or denial.

FIG. 8 is a flow chart representing a continued preferred sequence of steps for implementing TACS 100, if TACS 100 determines that the current purchase is a subsequent purchase (from FIG. 3). In step 800, TACS 100 preferably logs the TACS account number for the consumer. The consumer would have received an account number during a previous initial purchase from TACS (as described in step 301). Logging the consumer's TACS account number may aid in retrieving known consumer information and recording information for the present purchase.

Subsequent purchases of a TACS Product may generally require less scrutiny than an initial TACS Product purchase because the consumer has already once been authorized to purchase the TACS Product. However, some screening may still be performed, because there may have been a change in one or more substantive risk factors associated with the TACS Product. Therefore, in step 801, TACS 100 may collect both known and updated relevant information on the consumer. This step may at least partially mirror the actions undertaken in steps 402 and 403 of FIG. 4 and even steps 601-604 of FIG. 6, if desired. As before, TACS 100 may obtain consumer information from a variety of sources, including extant information in TACS data storage, Triage-managed self-identified consumer information, self-administered and professionally administered diagnostic testing, diagnostician/clinician examinations, more specialized diagnostic facility testing, etc. TACS 100 may also receive input from any special instructions or notations diagnostician/clinicians (or any authorized TACS affiliated person or computerized program) may have made for the consumer in question. For example, if a diagnostician/clinician has limited the purchase quantity of a product, or banned it outright for a particular consumer, TACS 100 may translate these notations into purchasing limitations or deauthorizations.

In step 802, TACS 100 preferably determines whether a quantity restriction has been placed on the TACS Product for the particular consumer as of the present date. As described above, limitations may be placed on both the quantity and time within which a re-order may be allowed. For subsequent TACS Product purchases, the sales quantity allotment specifies how many doses of the TACS Product can be purchased and/or consumed by the consumer over an allotted specified time period based on a per-product determination by a regulatory authority. For example, statin TACS Products may be authorized for up to a six-month period (e.g., 180 tablets for 180 days, assuming once daily dosage). After the six-month period expires, a diagnostic test (with a corresponding diagnostic test result for lipid, LDL and cholesterol levels and a liver enzyme panel) may be required by the Triage Service prior to the allowance of another six-month purchasing renewal period.

If the re-order request occurs prior to a restricted date demarking the end of a given time period, then, in step 805, the consumer may be denied purchasing authorization and advised of a date on which fulfillment of the re-order is permissible. Similarly, multiple re-orders may be held in a queue in a TACS pending order database. Once a restricted date has passed, automatic authorization and distribution of one or more queued orders may be allowed.

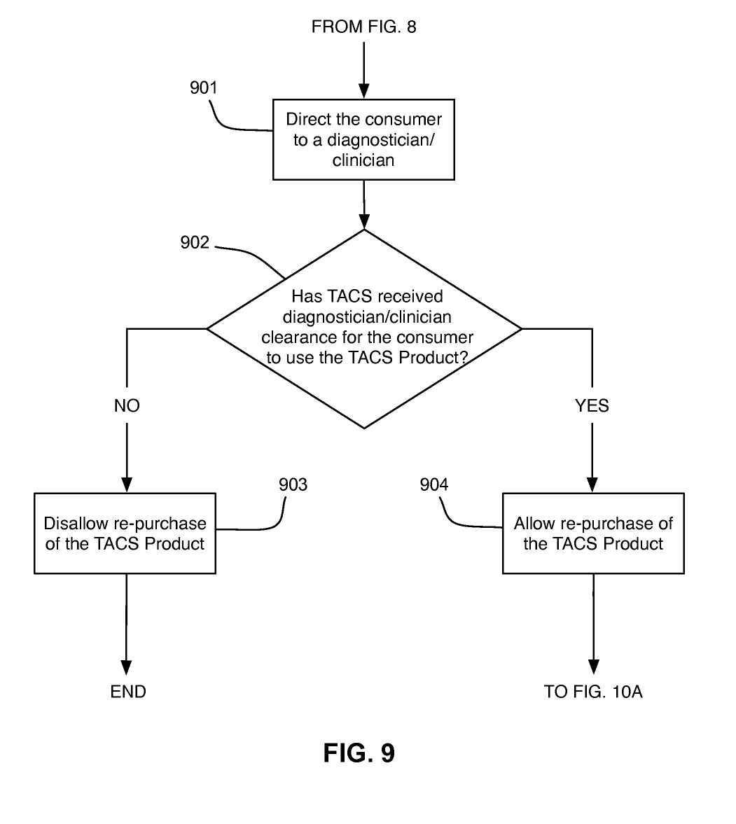

If there is no current restriction on the allotment of a TACS Product re-order, then in step 803, TACS 100 may then determine, based on the information it has collected, whether there has been a change in the substantive risk factors associated with the TACS Product being purchased. If there has been no change in the substantive risk factors sufficient to de-authorize future purchases, or if the change is substantive but does not require Triage-based de-authorization or a diagnostician/clinician follow-up, then, in step 804, the repurchase of the TACS Product may be authorized and the system may proceed to FIG. 10A. If, however, there has been a change in the consumer's substantive risk factors sufficient to de-authorize future purchases and for which a diagnostician/clinician visit is required, then the system may progress to FIG. 9.

FIG. 9 is a flow chart representing a continued preferred sequence of steps for implementing TACS 100, if TACS 100 has determined that there has been a change in the consumer's substantive risk factors for a subsequent repurchase of a TACS Product. In step 901, TACS 100 may require that the consumer undergo an examination and/or assessment by a diagnostician/clinician to determine whether the consumer may still utilize the TACS Product. In step 902, TACS 100 may await override authorization from the diagnostician/clinician. If the diagnostician/clinician fails to provide override authorization in an allotted time period, then, in step 903, the consumer may be denied authorization to repurchase the TACS Product, and the process may end. If, however, the diagnostician/clinician does provide override authorization in an allotted time period, then, in step 904, the consumer may be authorized for a repurchase of the TACS Product. In this case, the diagnostician/clinician may be required to provide a notice of allowance to TACS 100. The notice preferably includes information including a description of the TACS Product, the diagnostician/clinician's name and address, the consumer's identification information and, of course, the actual allowance override authorization issued by the diagnostician/clinician.

FIG. 10A is a flow chart representing a continued preferred sequence of steps for implementing TACS 100, if a consumer has obtained TACS 100 authorization to purchase a TACS Product. In step 1001, TACS 100 may clear the TACS Product for sale to the consumer once all requirements have been met for selling the TACS Product.

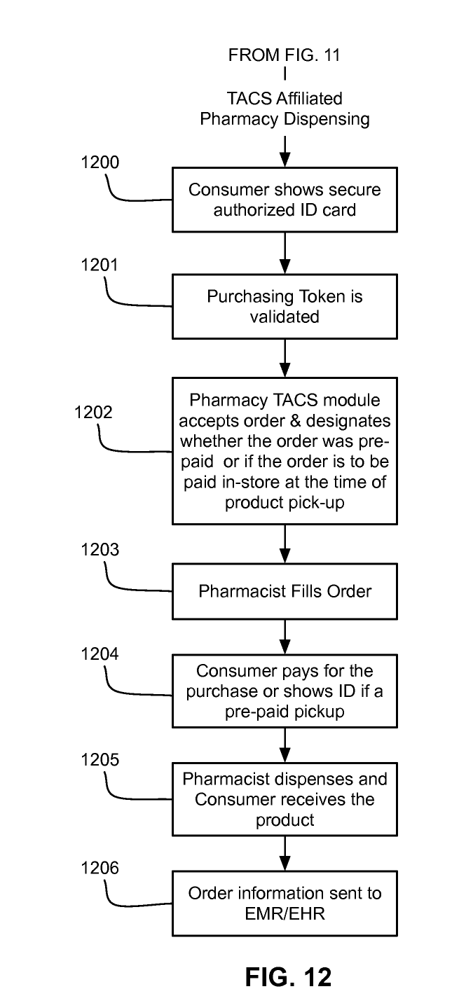

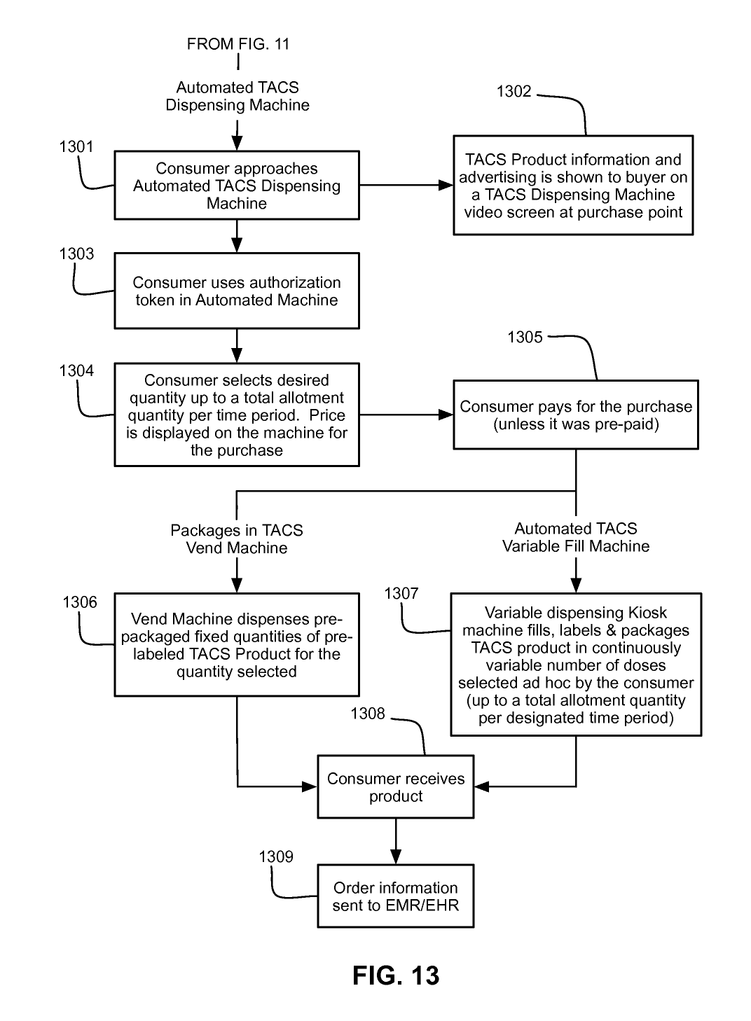

In step 1002, TACS 100 may send the order information to the Order Intake Service module 3. Order Intake Service module 3 may also transmit information specific to the order to Order Fulfillment & Shipping Service Module 4 for shipment processing. A preferred TACS Product delivery method may be indicated by the consumer at this time. Upon ordering a TACS Product, the consumer may choose to receive their TACS Product either through mail/parcel shipment delivery or at a TACS affiliated retail location connected to TACS 100 through Network 13 for pick-up by an authorized individual (described in FIGS. 12 and 13).

Because a significant span of time may sometimes pass between the commencement of the ordering process and the issuance of a TACS Product purchasing authorization, it may be necessary for Order Intake Service module 3 to contact the consumer to confirm the consumer's continued interest in purchasing the TACS Product and fulfilling the order. The order may also be accepted automatically upon the issuance of purchasing authorization, if the consumer has approved of such an action at the time of the original order request.

FIG. 10B is a flow chart representing a continued preferred sequence of steps for implementing TACS 100, if the consumer elects mail/parcel shipment delivery. TACS 100 preferably initiates execution of the payment process, which is preferably completed before shipping of the TACS Product is commenced. The consumer's credit card is preferably not charged until the product order enters the actual shipping process within the advertised time period to the consumer indicating when shipping may be expected to occur and be received. Therefore, in step 1003, Order Intake Service module 3 may send consumer payment information to the Banking Service module 5, which is preferably the financial institution or other organization providing services to the Health Care Product Company for purchase verification so that the purchase on the credit card may be approved or denied. The Card Association (such as Visa®, MasterCard®, American Express®, etc.) preferably acts as a gateway between the Banking Service module 5 and the Card Issuer (the financial institution or organization that issued the credit card to the consumer) for authorizing and funding the transaction. In step 1004, the Banking Service module 5 may verify with the Card Issuer that the card number and transaction amount are both valid. After the transaction is authorized, in step 1005, notice of the authorization may then be stored in a batch file by the Order Intake Service module 3. In step 1006, Order Intake Service module 3 sends the batch file to Banking Service module 5 preferably at the end of any given day. In step 1007, Order Fulfillment & Shipping Service module 4 may then authorize the TACS Product for retrieval and preparation for shipment. The TACS Product may then be retrieved from warehouse stock, or ordered from the manufacturer if stocks are depleted. Alternatively, a product kit may be assembled. Product kits may contain multiple purchased products, some of which are TACS Products and some of which may be other supplemental or secondary products not necessarily requiring TACS sales protocols or authorizations. These secondary products may add value to the whole due to some commercial relationship with the TACS product. For example, secondary product skin hydrating creams may be purchased along with a TACS Product for treating eczema.

FIG. 10C is a flow chart representing a continued preferred sequence of steps for implementing TACS 100. When product shipment occurs, in step 1008, Order Fulfillment & Shipping Service module 4 may concurrently send a data file to Banking Service module 5 indicating that payment is ready to be accepted. In step 1008a, the order information may also be sent to and stored in EMR/EHR systems (as described above). In step 1009, Banking Service module 5 preferably sends any pending transactions in the batch file through the Card Association, which, in step 1010, may debit the Card Issuers for payment, and, in step 1011, credits the Banking Service module 5. Finally, in step 1012 the TACS Product preferably reaches its target destination and is received by the consumer.

Obviously, cash or other forms of payment may also be used to make purchases from TACS 100 as desired. If a money order is used instead of a credit card, it is preferably sent to and received by the Order Fulfillment Service & Shipping Company, and subsequently deposited in the Banking Service module 5 for processing.

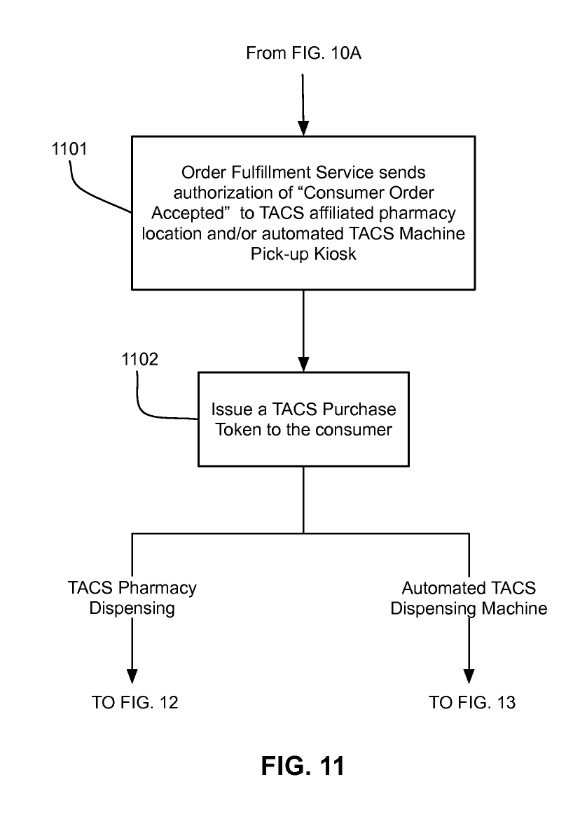

As described above, rather than have the TACS Product shipped or mailed to the consumer, the consumer may wish instead to purchase or pick up their TACS Product at a TACS affiliated retail sales or pickup location. FIG. 11 is a flow chart representing a continued preferred sequence of steps for implementing TACS 100, depicting a preferred sequence of steps for acquiring a TACS Product from either a TACS affiliated Pharmacy or from an Automated TACS Product Dispensing Machine.

In step 1101, Order Fulfillment & Shipping Service module 4 may send an authorization to either a TACS Pharmacy Dispensing module 6A or to an Automated TACS Dispensing Machine 6B (or to both assuming that pick up at either location will satisfy the sale). Successful product pick-ups may be recorded by TACS 100, thereby preventing repeated pickups for the same product by the same consumer.

A TACS Pharmacy module 6A that has received an authorization may allow a TACS affiliated Pharmacy to release the TACS Product to the consumer in a quantity not to exceed the minimum and/or a maximum consumption allotment amounts per specified time period (as discussed previously). Similarly, an Automated TACS Product Dispensing machine 6B location that has received such an authorization may release the TACS Product in a quantity not to exceed the minimum and/or a maximum consumption allotment amounts per specified time period, as discussed previously.

If the TACS Product is to be picked-up at a retail location, TACS 100 may send a notification through Network 13 to the consumer (which, for example, may take the form of e-mail, text messaging service, automatic phone notification, etc.), advising the consumer that the order is ready for pick-up at any TACS Product pick-up location (e.g., TACS Pharmacy or any Automated TACS Product Dispensing machine). The pick-up location may be pre-designated by the consumer, or suggested automatically by TACS 100 based on the consumer's physical address.

In step 1102, Triage Service module 2 may provide the consumer with an authorization token or purchase code to purchase the TACS Product. The token may take the form of, for example, a purchase authorization card with an attached code, or a code associated with a user's TACS ID. A TACS ID or purchase authorization card may be encoded with information via, for instance, alphanumeric code, graphical code, magnetic strip, etc. Alternatively, the token may comprise an authorized purchase code sent to the consumer through the mail, transmitted orally over telephone, received digitally through the Internet, or through other appropriate means. The token is preferably secured against counterfeiting, electronic spoofing and other common forms of obtaining illicit access. The token may enable the consumer to purchase their TACS Product from a retail TACS Pharmacy (presumably from a pharmacist or other authorized Pharmacy personnel) connected to TACS Pharmacy Dispensing Module 6A, or from an Automated TACS Dispensing Machine connected to Closed System Automated TACS Dispensing Machine Module 6B. The token may also allow the consumer to partake in Triage services, and make additional TACS purchases through an internet-enabled TACS Product gateway on any computer or computing system. If a token is not readily available to the consumer, the TACS Pharmacist or Automated TACS Dispensing machine may be able to look up the consumer's token with proper additional identification or other means. For example, the machine may be equipped with some form of identification confirmation system, such as (but not limited to) facial recognition, retina scanning, fingerprint scanning, etc.

FIG. 12 is a flow chart representing a continued preferred sequence of steps for implementing TACS 100, depicting a preferred sequence of steps for acquiring a TACS Product from a TACS affiliated Pharmacy. In step 1200, the consumer preferably presents the secure authorized ID card (or other token) to authenticate the consumer for the purpose of TACS Product pick-up. When the consumer visits a TACS Pharmacy to purchase and/or pick-up a pre-paid TACS Product, the consumer may show its authorized TACS token to the authorized store personnel.

In step 1201, the TACS authorization token associated with the consumer may be retrieved and, validated with a confirmation check against a TACS 100 database. In step 1202, the TACS Pharmacy Dispensing module 6A may accept the purchase order as authorized (under any previously ordained restrictions) and determine whether the order was prepaid or if the order is to be paid in-store at the time of product pick-up. Subsequently, in step 1203, the pharmacist (or other store personnel, if permitted) preferably fills the order. In step 1204, payment is preferably completed at the point-of-purchase, unless, as determined above, it was pre-paid at the time of ordering. If the TACS Product was pre-paid during the initial ordering process, then the consumer may be required only to show appropriate identification at pick-up. A dispensing fee may be added to the cost of the TACS Product to compensate the pharmacist for filling the order. Finally, in step 1205, the consumer preferably receives the TACS Product. In step 1206, the order information may be sent to an EMR/EHR system.

FIG. 13 is a flow chart representing a continued preferred sequence of steps for implementing TACS 100, if the consumer chooses to receive the product from an Automated TACS Dispensing Machine 6B. In step 1301, the consumer may approach an Automated TACS Dispensing Machine 6B to purchase and/or pick-up the TACS Product. In step 1302, the TACS Dispensing Machine 6B preferably provides the Consumer with information about the TACS Product.

In step 1303, the Consumer may input the consumer's TACS-issued token authorization into the Automated TACS Dispensing Machine 6B. For example, the consumer may have a TACS ID card read by a card reader integrated into the Automated TACS Dispensing Machine 6B. Alternatively, the consumer may input the TACS Product code into a kiosk keyboard or touch-input video screen. An accepted token may qualify the consumer to purchase TACS Products from the Automated TACS Dispensing Machine 6B consistent with any current TACS authorization and restrictions on quantity and/or time period.

In step 1304 the consumer preferably selects which TACS Product(s) the consumer intends to purchase (up to a total approved allotment quantity for that TACS Product specific to the purchasing consumer), and specifies the quantity of the order. The Automated TACS Dispensing Machine 6B may show the consumer the price charged for the quantity selected. In step 1305, the consumer preferably pays for the purchase. If the order is a pre-arranged and/or pre-paid purchase (for example, if the order was input into TACS 100 by Order Intake Service module 3, Order Fulfillment & Shipping Service module 4, or by the consumer through Consumer module 11), then this step may be omitted since the order and/or payment are already stored in the TACS system 100. Payment may be made in any convenient or desirable format. Payment is preferably cleared by the Banking Service module 5 before the Automated TACS Dispensing Machine 6B dispenses the TACS Product. For example, if a credit card is utilized as payment, the credit card information preferably clears the Banking Service module 5 before actual provision of the TACS Product to the consumer begins. Alternatively, if cash tender is deposited in the machine, the machine may determine whether the deposited amount is sufficient to cover the cost of the TACS Product (and may issue change if necessary). Once payment has been perfected, then the Automated TACS Dispensing Machine 6B may dispense the TACS Product to the consumer.

TACS Product pick-up machines 6B may come in two or more formats. For example, the machine may contain pre-packaged, sealed and labeled fixed quantities of TACS Products filled in one or more pre-filled unit quantities in each package. For example, the packages may come in 25, 100 and 200 count containers. Alternatively, the Automated TACS Dispensing Machine 6B may have the capability to automatically fill a container with a variable number of consumer selected dosage forms, which the consumer may select at the machine at the point of purchase. After filling the container, the Automated TACS Dispensing Machine 6B may seal and label the bottle (or other container) for the individual consumer and dispense it to the consumer on demand after having cleared authorization and payment.

If the Automated TACS Dispensing Machine 6B is a vend-style machine containing pre-packaged fixed quantity pre-labeled TACS Products, then, in step 1306, the vend-style Automated TACS Dispensing Machine 6B may dispense the selected package(s) to the consumer.

If the Automated TACS Dispensing Machine 6B is a variable quantity dispensing unit, with the ability to fill, package and label TACS Products in variable quantities chosen by the consumer, then, in step 1307, the consumer preferably selects which product the consumer intends to buy from the Automated TACS Dispensing Machine 6B, and what quantity the consumer wishes to purchase (up to the total approved TACS Product allotment quantity if any has been designated for the product). The Automated TACS Dispensing Machine 6B may then fill the product order from an existing (and presumably replenishable) stock stored in the machine by retrieving the specified units and installing them into a container, capping or otherwise sealing the container and labeling the container with a TACS appropriate label. The label may be printed on the container or on a self-adhesive label that may be affixed to the container by the Automated TACS Dispensing Machine 6B prior to dispensing it for consumer pickup. The Automated TACS Dispensing Machine 6B preferably contains replenishable stocks of the container, label and closure materials. The Automated TACS Dispensing Machine 6B also preferably includes the ability to print text (or even images) on the labels (through, for example, ink to paper transfer, or a thermal heat printing process). Finally, in step 1308, the Automated TACS Dispensing Machine 6B preferably dispenses the package(s) of TACS Product to be retrieved by the consumer. In step 1309, the order information may be sent to an EMR/EHR system.

Other enclosures, such as (but not limited to) sealed or otherwise securely closed pouches, may be used in the Automated TACS Dispensing Machine 6B in place of containers (e.g., bottles or vials, etc.), which would not require capping. For example, tablets may be dispensed in individually pouched strips with a means to separate each dosage unit, so the strips can be separated without ripping open the pouch. This may be an advantageous method of dispensing certain TACS Products, such as, for example, certain drugs or medical devices (e.g., contact lenses).

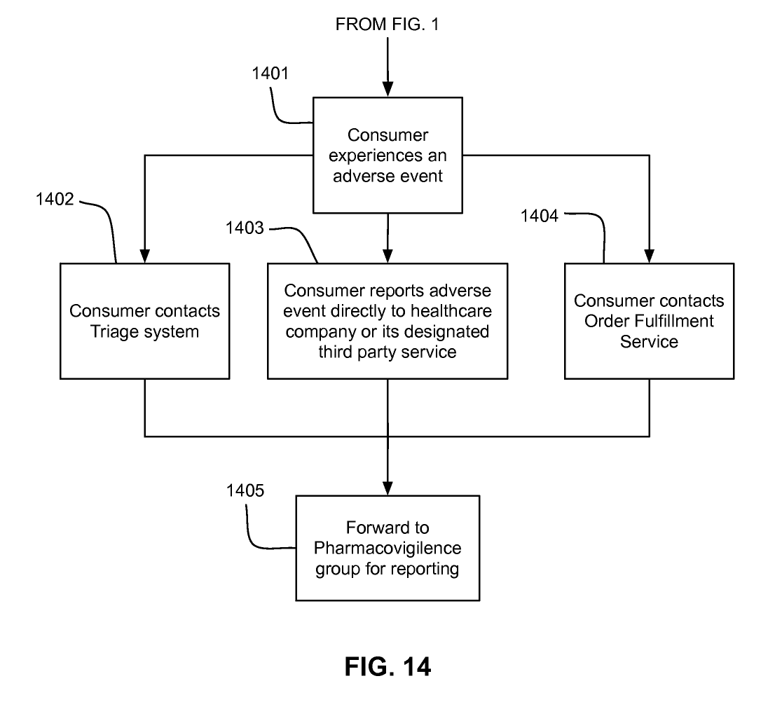

FIG. 14 is a flow chart representing a continued preferred sequence for implementing TACS 100, illustrating a preferred sequence of steps for implementing pharmacovigilance capture and reporting. In step 1401, the consumer may experience an AE, which is any undesirable or unexpected experience associated with the use of a drug, biologic, medicinal or medical health care product, medical device and/or diagnostic or genetic test. Reporting of AE's is useful because it helps regulatory authorities, manufacturers, physicians and other health care related personnel or industries to identify, evaluate and manage a plurality of factors, including potential risks and complications, safety concerns, gaps in product use and drug-drug, drug-food or drug-test interaction education. Indeed, AE reporting has the potential to remove potentially dangerous products from the market AE reporting allows for the capturing of trends indicating the potential for such danger over time and for a particular usage population. At a minimum, labeling or counseling may be modified so that safer product usage may be better ensured. TACS 100 may significantly improve AE reporting for drugs, biologics and medical devices, diagnostic tests, etc.

Pharmacovigilance departments are typically maintained within health care companies to identify, aggregate and analyze the data provided to them on AE's. Therefore, consumer reports on AE's may be reported to a regulatory authority and acted upon if necessary.

In steps 1402 and 1404, the consumer may contact TACS 100 through the Triage Service module 2 and/or the Order Fulfillment & Shipping Service module 4, respectively, to report an AE. Alternatively, in step 1403, the consumer may directly contact the health care company or a third party service under contract to the health care company to report an AE. Reporting may be executed via, for example, calling a designated telephone number listed on the TACS Product package or TACS Product website. Alternatively, the AE reporter may use a hyperlink on a TACS Product website to navigate to a web page linked directly to a department in the company responsible for pharmacovigilence. In step 1405, the consumer is preferably directed to Customer Support Group module 7 (i.e., the support group associated with the product that ostensibly caused the AE responsible for answering TACS Product specific questions on safety and/or efficacy) in order to conduct required pharmacovigilance data collection and processing. The Customer Support Group may also respond to consumer questions specific to the TACS Product unrelated to AE's, such as proper usage of the TACS Product.

Alternatively, or supplementally, TACS 100 may include a TACS Consumer Support Department separate from the health care company Customer Support Group. A consumer inquiry received by the TACS Consumer Support Group may be transferred to the health care company Customer Support Group module 7 for handling relevant issues. For example, the TACS Consumer Support Group may conduct pharmacovigilance on behalf of the health care company, assuming this service is approved by the health care company and/or the regulatory authority. Pharmacovigilance handlers in TACS 100 may then record the relevant information (as required by the regulatory authority) and transmit that information to all relevant parties, such as (but not limited to) Regulatory Authority module 1 and the Health Care Company module 12.

If a TACS Product return transaction is warranted, the TACS Product may be returned through the mail or parcel shipping service by the consumer to an authorized TACS Product Fulfillment Company through Order Fulfillment & Shipping Service module 4. Once the returned TACS Product is logged in as having been received by the TACS Order Fulfillment & Shipping Service module 4, the Banking Service module 5 may be instructed to credit a relevant consumer account, send the consumer a refund check, or otherwise refund money to the consumer.

Software process or processes and executables on the computing system may be used to provide human interfaces and to store and initiate computer program instructions used to process and analyze data. Computer program code for carrying out operations described herein may be written in any combination of one or more programming languages, including an object oriented programming language such as Java, SaaS, C++, C# or the like and conventional procedural programming languages, such as the “C” programming language or similar programming languages. The program code may execute entirely on the computing system, partly on the computing system, as a stand-alone software package, partly on the computing system and partly on a remote computer or server, or entirely on a remote computer or server.

This application was described above with reference to flow chart illustrations and/or block diagrams of methods, apparatus (systems) and computer program products according to one or more embodiments. It is understood that some or all of the blocks of the flow chart illustrations and/or block diagrams, and combinations of blocks in the flow chart illustrations and/or block diagrams, can be implemented by computer program instructions. The computer program instructions may also be loaded onto the computing system to cause a series of operational steps to be performed on the computer to produce a computer implemented process such that the instructions that execute on the computer provide processes for implementing the functions/acts specified in the flowchart and/or block diagram block(s). These computer program instructions may be provided to the CPU of the computing system such that the instructions, which execute via the CPU of the computing system, create means for implementing the functions/acts specified in the flowchart and/or block diagram block(s).

These computer program instructions may also be stored in a computer-readable medium that can direct the computing system to function in a particular manner, such that the instructions stored in the computer-readable medium implement the function/act specified in the flowchart and/or block diagram block or blocks. Any combination of one or more computer usable or computer readable medium(s) may be utilized. The computer-usable or computer-readable medium may be, for example (but not limited to), an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory, a read-only memory, an erasable programmable read-only memory (e.g., EPROM or Flash memory), an optical fiber, a portable compact disc read-only memory, an optical storage device, a transmission media such as those supporting the Internet or an intranet, or a magnetic storage device. Any medium suitable for electronically capturing, compiling, interpreting, or otherwise processing in a suitable manner, if necessary, and storing into computer memory may be used. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in base band or as part of a carrier wave. The computer usable program code may be transmitted using any appropriate medium, including (but not limited to) wireless, wire line, optical fiber cable, RF, etc.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A closed system for controlling distribution of regulated health care related products, comprising:
a processor;
a database coupled to the processor, the database including
a listing of at least one healthcare related product for purchase, the at least one healthcare related product of a type that is access controlled based upon predefined medical criteria, and
stored qualification factors for each healthcare related product listed in the database, the qualification factors specifying medical information that must be satisfied before the healthcare related product can be distributed to an end user of the healthcare related product;
a customer interface through which requests can be made to obtain healthcare related products for the end user;
a communication link through which distribution of the healthcare related products can be directed; and
a triage module, the triage module implemented by program instructions executable by the processor, to:
interact with the customer interface to receive a request from a requesting customer to purchase at least one healthcare related product listed in the database;
access the database to obtain the qualification factors for the requested healthcare related product;
receive medical information relating to the end user of the requested healthcare related product that can be used to determine whether the qualification factors for the requested healthcare related product are satisfied;
determine whether the qualification factors are satisfied based on the received medical information;
issue an indication via the communication link that the requested healthcare related product should be distributed to the end user if the qualification factors are satisfied; and
if any of the qualification factors are not satisfied, cause the customer interface to indicate to the requesting customer that further action is required to satisfy the qualification factors before the requested healthcare related product may be distributed to the end user.

2. The system of claim 1, wherein the triage module is further implemented by program instructions executable by the process to:
receive an override from a diagnostician/clinician authorizing the distribution of the requested healthcare related product to the end user if any of the qualification factors are not satisfied; and
cause the customer interface to issue an indication via a communication link that the requested healthcare related product should be distributed to the end user despite the fact that all qualification factors are not satisfied.

3. The system of claim 1, wherein the triage module is further implemented by program instructions executable by the process to:
receive an override from a diagnostician/clinician declining the distribution of the requested healthcare related product to the end user if the qualification factors are satisfied; and
withdraw the indication via a communication link that the requested healthcare related product should be distributed to the end user despite the fact that all qualification factors are satisfied.

4. The system of claim 1, wherein the medical information relating to the end user is received from stored electronic medical or health records.

5. The system of claim 1, wherein the medical information relating to the end user is received from the requesting customer via the customer interface.

6. The system of claim 1, wherein the received medical information relating to the end user includes data from results of one or more diagnostic tests performed on the end user.

7. The system of claim 1, wherein the triage module is further implemented by program instructions executable by the processor to communicate information relating to the requested healthcare product to the requesting customer via the customer interface.

8. The system of claim 1, wherein the stored qualification factors include one or more health risk factors associated with the healthcare related product.

9. The system of claim 8, wherein the health risk factors include at least one of age, weight, gender, health-effecting personal habits, personal medical history, family medical history, and the presence of one or more physical, genetic or biologic pre-existing conditions.

10. A computer-implemented method for controlling the closed distribution of regulated health care related products, comprising:
receiving a request to purchase a healthcare related product listed in a database from a requesting customer via a customer interface, the healthcare related product of a type that is access controlled based upon predefined medical criteria;
accessing the database, using a processor, to obtain qualification factors stored in the database for the requested healthcare related product, the qualification factors specifying medical information that must be satisfied before the requested healthcare related product can be distributed to an end user of the requested healthcare related product;
receiving, using the processor, medical information relating to the end user of the requested healthcare related product;
determining, using the processor, whether the qualification factors for the requested healthcare related product are satisfied based on the received medical information; and
issuing an indication via a communication link that the requested healthcare related product should be distributed to the end user if the qualification factors are satisfied.

11. The method of claim 10, further comprising, if any of the qualification factors are not satisfied, causing the customer interface to indicate to the requesting customer that further action is required to satisfy the qualification factors before the requested healthcare related product can be distributed to the end user.

12. The method of claim 10, further comprising:
if any of the qualification factors are not satisfied, receiving, using the processor, an override from a diagnostician/clinician authorizing the distribution of the requested healthcare related product to the end user; and
issuing an indication via the communication link that the requested healthcare related product should be distributed to the end user despite the fact that all qualification factors are not satisfied.

13. The method of claim 10, further comprising:
if the qualification factors are satisfied, receiving, using the processor, an override from a diagnostician/clinician declining the distribution of the requested healthcare related product to the end user; and
withdrawing the indication via the communication link that the requested healthcare related product should be distributed to the end user despite the fact that all qualification factors may be satisfied.

14. The method of claim 10, wherein the medical information relating to the end user of the requested healthcare related product is received from stored electronic medical or health records of the end user.

15. The method of claim 10, wherein the medical information relating to the end user of the requested healthcare related product is received from the requesting customer via the customer interface.

16. The method of claim 10, wherein the medical information relating to the end user of the requested healthcare related product is received from a designated diagnostician/clinician for the end user via a medical professional interface.

17. The method of claim 10, wherein the medical information relating to the end user of the requested healthcare related product includes data from results of one or more diagnostic tests performed on the end user.

18. The method of claim 10, further comprising communicating information relating to the requested healthcare product to the requesting customer via the customer interface.

19. The method of claim 10, wherein the stored qualification factors include one or more health risk factors associated with the requested healthcare related product.

20. The method of claim 19, wherein the health risk factors include one or more of age, weight, gender, health-effecting personal habits, personal medical history, family medical history, and the presence of one or more physical, genetic or biologic pre-existing conditions.
